(19) United States
(12) Patent Application Publication
(10) Pub. No.: US 2026/0204251 A1
(43) Pub. Date: Jul. 16, 2026

(54) SPEECH SYNTHESIS METHOD

(71) Applicant: Tencent Technology (Shenzhen) Company Limited, Shenzhen (CN)

(72) Inventors: Yongxin ZHU, Shenzhen (CN); Dan SU, Shenzhen (CN)

(73) Assignee: Tencent Technology (Shenzhen) Company Limited, Shenzhen, GD (CN)

(21) Appl. No.: 19/564,152

(22) Filed: Mar. 11, 2026

Related U.S. Application Data
(63) Continuation of application No. PCT/CN2024/115324, filed on Aug. 29, 2024.

(30) Foreign Application Priority Data
Nov. 27, 2023 (CN) 202311603829.6

(51) Int. Cl. G10L 13/047; G10L 13/08

(52) U.S. Cl. CPC G10L 13/047; G10L 13/08

(57) ABSTRACT

In a speech synthesis method, a semantic feature of text information that corresponds to content of to-be-synthesized target audio is acquired, and an acoustic feature of reference speech that corresponds to a target timbre of the to-be-synthesized target audio is acquired. In the method, an intermediate acoustic feature is obtained through a first-layer sub-model in a speech synthesis model, the first-layer sub-model being configured to output feature values of the intermediate acoustic feature based on the semantic feature and the acoustic feature. In the method, an audio synthesis feature is obtained through a second-layer sub-model in the speech synthesis model, the second-layer sub-model being configured to output feature values of the audio synthesis feature based on the intermediate acoustic feature. In the method, target audio conforming to the target timbre of the reference speech is generated based on the audio synthesis feature.

### RELATED APPLICATIONS

The present application is a continuation of International Application No. PCT/CN2024/115324, filed on Aug. 29, 2024, which claims priority to Chinese Patent Application No. 202311603829.6, filed on Nov. 27, 2023, and entitled “SPEECH SYNTHESIS METHOD AND APPARATUS, DEVICE, STORAGE MEDIUM, AND PROGRAM PRODUCT.” The entire disclosures of the prior applications are hereby incorporated by reference.

### FIELD OF THE TECHNOLOGY

Embodiments of this disclosure relate to the technical field of speech synthesis, including a speech synthesis method and apparatus, device, storage medium, and program product.

### BACKGROUND OF THE DISCLOSURE

With the development of deep learning, speech synthesis technologies have achieved rapid advancement. A realistic and natural speech synthesis technology has been applied to speech interaction systems such as a mobile phone speech assistant, a smart speaker, and an in-vehicle computer of an automobile. Meanwhile, user demand for speech synthesis technologies is increasing, and technical requirements are correspondingly rising. Users not only expect synthesized speech to rival natural human pronunciation, but also desire diverse timbres including those of family members and friends.

In the related art, during speech synthesis, a text sequence is inputted into a trained speech synthesis model, and the speech synthesis model may automatically generate synthesized audio according to the text. In some applications, after a text sequence is inputted, the speech synthesis model first maps the text sequence to obtain a corresponding audio feature, and then converts the audio feature into sound that we can understand, that is, synthesized audio.

However, the foregoing method can only rigidly simulate real speech. The generated synthesized audio fails to conform to actual sound production characteristics of a person, resulting in poor authenticity of the synthesized audio.

### SUMMARY

This disclosure provides a speech synthesis method and apparatus, a device, a storage medium, and a program product. The technical solutions include the following.

According to an aspect of this disclosure, a speech synthesis method is provided. In the method, a semantic feature of text information that corresponds to content of to-be-synthesized target audio is acquired, and an acoustic feature of reference speech that corresponds to a target timbre of the to-be-synthesized target audio is acquired. In the method, an intermediate acoustic feature is obtained by processing circuitry through a first-layer sub-model in a speech synthesis model, the first-layer sub-model being configured to output feature values of the intermediate acoustic feature based on the semantic feature and the acoustic feature. In the method, an audio synthesis feature is obtained by the processing circuitry through a second-layer sub-model in the speech synthesis model, the second-layer sub-model being configured to output feature values of the audio synthesis feature based on the intermediate acoustic feature. In the method, target audio conforming to the target timbre of the reference speech is generated based on the audio synthesis feature.

According to an aspect of this disclosure, a method for training a speech synthesis model is provided. In the method, sample audio that corresponds to a reference timbre is acquired, a sample semantic feature of the sample audio is acquired, and a sample acoustic feature of sample reference speech that corresponds to the reference timbre is acquired. In the method, a sample intermediate acoustic feature is obtained by processing circuitry through a first-layer sub-model in a speech synthesis model, the first-layer sub-model being configured to output feature values of the intermediate acoustic feature based on the sample semantic feature and the sample acoustic feature. In the method, an audio synthesis feature is obtained by the processing circuitry through a second-layer sub-model in the speech synthesis model, the second-layer sub-model being configured to output feature values of the audio synthesis feature based on the sample intermediate acoustic feature. In the method, synthesized audio based on the audio synthesis feature is generated. In the method, a training loss of the speech synthesis model is calculated based on the sample audio and the synthesized audio. In the method, model parameters of the speech synthesis model are updated according to the training loss.

According to an aspect of this disclosure, a speech synthesis apparatus is provided. The apparatus includes processing circuitry configured to acquire a semantic feature of text information that corresponds to content of to-be-synthesized target audio, and to acquire an acoustic feature of reference speech that corresponds to a target timbre of the to-be-synthesized target audio. The processing circuitry is configured to obtain an intermediate acoustic feature through a first-layer sub-model in a speech synthesis model, the first-layer sub-model being configured to output feature values of the intermediate acoustic feature based on the semantic feature and the acoustic feature. The processing circuitry is configured to obtain an audio synthesis feature through a second-layer sub-model in the speech synthesis model, the second-layer sub-model being configured to output feature values of the audio synthesis feature based on the intermediate acoustic feature. The processing circuitry is configured to generate, based on the audio synthesis feature, target audio conforming to the target timbre of the reference speech.

According to an aspect of this disclosure, a speech synthesis model training apparatus is provided. The apparatus includes processing circuitry configured to acquire sample audio that corresponds to a reference timbre, to acquire a sample semantic feature of the sample audio, and to acquire a sample acoustic feature of sample reference speech that corresponds to the reference timbre. The processing circuitry is configured to obtain a sample intermediate acoustic feature through a first-layer sub-model in a speech synthesis model, the first-layer sub-model being configured to output feature values of the intermediate acoustic feature based on the sample semantic feature and the sample acoustic feature. The processing circuitry is configured to obtain an audio synthesis feature through a second-layer sub-model in the speech synthesis model, the second-layer sub-model being configured to output feature values of the audio synthesis feature based on the sample intermediate acoustic feature. The processing circuitry is configured to generate synthesized audio based on the audio synthesis feature. The processing circuitry is configured to calculate a training loss of the speech synthesis model based on the sample audio and the synthesized audio. The processing circuitry is configured to update model parameters of the speech synthesis model according to the training loss.

According to an aspect of this disclosure, a non-transitory computer-readable storage medium storing instructions is provided. The non-transitory computer-readable storage medium stores instructions, which when executed by a processor, cause the processor to perform a speech synthesis method. In the method, a semantic feature of text information that corresponds to content of to-be-synthesized target audio is acquired, and an acoustic feature of reference speech that corresponds to a target timbre of the to-be-synthesized target audio is acquired. In the method, an intermediate acoustic feature is obtained through a first-layer sub-model in a speech synthesis model, the first-layer sub-model being configured to output feature values of the intermediate acoustic feature based on the semantic feature and the acoustic feature. In the method, an audio synthesis feature is obtained through a second-layer sub-model in the speech synthesis model, the second-layer sub-model being configured to output feature values of the audio synthesis feature based on the intermediate acoustic feature. In the method, target audio conforming to the target timbre of the reference speech is generated based on the audio synthesis feature.

According to an aspect of this disclosure, a non-transitory computer-readable storage medium storing instructions is provided. The non-transitory computer-readable storage medium stores instructions, which when executed by a processor, cause the processor to perform a method for training a speech synthesis model. In the method, sample audio that corresponds to a reference timbre is acquired, a sample semantic feature of the sample audio is acquired, and a sample acoustic feature of sample reference speech that corresponds to the reference timbre is acquired. In the method, a sample intermediate acoustic feature is obtained through a first-layer sub-model in a speech synthesis model, the first-layer sub-model being configured to output feature values of the intermediate acoustic feature based on the sample semantic feature and the sample acoustic feature. In the method, an audio synthesis feature is obtained through a second-layer sub-model in the speech synthesis model, the second-layer sub-model being configured to output feature values of the audio synthesis feature based on the sample intermediate acoustic feature. In the method, synthesized audio based on the audio synthesis feature is generated. In the method, a training loss of the speech synthesis model is calculated based on the sample audio and the synthesized audio. In the method, model parameters of the speech synthesis model are updated according to the training loss.

According to an aspect of this disclosure, a speech synthesis method is provided, including: acquiring a semantic feature and an acoustic feature, the semantic feature being configured to represent a feature of text information corresponding to to-be-synthesized target audio, the acoustic feature being a feature of acoustic information corresponding to reference speech, and the reference speech referring to speech of an object corresponding to a selected timbre; embedding the semantic feature into the acoustic feature through a first-layer sub-model in a speech synthesis model to obtain an intermediate acoustic feature, the first-layer sub-model being configured to embed the semantic feature into the acoustic feature, and the intermediate acoustic feature being configured to represent a feature obtained by embedding the semantic feature into the acoustic feature; inputting the intermediate acoustic feature into a second-layer sub-model in the speech synthesis model to obtain an audio synthesis feature, the second-layer sub-model being configured to synthesize the audio synthesis feature based on the intermediate acoustic feature, and the audio synthesis feature being configured to represent a feature corresponding to the to-be-synthesized target audio; and generating, based on the audio synthesis feature, synthesized audio having a same timbre as the reference speech.

According to an aspect of this disclosure, a method for training a speech synthesis model is provided, including: acquiring a sample semantic feature, a sample acoustic feature, and sample audio, the sample semantic feature being configured to represent a feature of text information corresponding to to-be-synthesized target audio, the sample acoustic feature being a feature of acoustic information corresponding to sample reference speech, and the sample reference speech referring to speech of an object corresponding to a selected timbre; embedding the sample semantic feature into the sample acoustic feature through a first-layer sub-model in the speech synthesis model to obtain a sample intermediate acoustic feature, the first-layer sub-model being configured to embed the sample semantic feature into the sample acoustic feature, and the sample intermediate acoustic feature being configured to represent a feature obtained by embedding the sample semantic feature into the sample acoustic feature; inputting the sample intermediate acoustic feature into a second-layer sub-model in the speech synthesis model to obtain an audio synthesis feature, the second-layer sub-model being configured to synthesize the audio synthesis feature based on the sample intermediate acoustic feature, and the audio synthesis feature being configured to represent a feature corresponding to the to-be-synthesized target audio; generating, based on the audio synthesis feature, synthesized audio having a same timbre as the sample reference speech; calculating a training loss of the speech synthesis model based on the sample audio and the synthesized audio; and updating model parameters of the speech synthesis model according to the training loss.

According to an aspect of this disclosure, a speech synthesis apparatus is provided, including: an acquisition module, configured to acquire a semantic feature and an acoustic feature, the semantic feature being configured to represent a feature of text information corresponding to to-be-synthesized target audio, the acoustic feature being a feature of acoustic information corresponding to reference speech, and the reference speech referring to speech of an object corresponding to a selected timbre; a feature processing module, configured to embed the semantic feature into the acoustic feature through a first-layer sub-model in a speech synthesis model to obtain an intermediate acoustic feature, the first-layer sub-model being configured to embed the semantic feature into the acoustic feature, and the intermediate acoustic feature being configured to represent a feature obtained by embedding the semantic feature into the acoustic feature; and the feature processing module being configured to input the intermediate acoustic feature into a second-layer sub-model in the speech synthesis model to obtain an audio synthesis feature, the second-layer sub-model being configured to synthesize the audio synthesis feature based on the intermediate acoustic feature, and the audio synthesis feature being configured to represent a feature corresponding to the to-be-synthesized target audio; and a generation module, configured to generate, based on the audio synthesis feature, synthesized audio having a same timbre as the reference speech.

According to an aspect of this disclosure, an apparatus for training a speech synthesis model is provided, including: an acquisition module, configured to acquire a sample semantic feature, a sample acoustic feature, and sample audio, the sample semantic feature being configured to represent a feature of semantic text information corresponding to to-be-synthesized target audio, the sample acoustic feature being a feature of acoustic information corresponding to sample reference speech, and the sample reference speech referring to speech of an object corresponding to a selected timbre; a feature processing module, configured to embed the sample semantic feature into the sample acoustic feature through a first-layer sub-model in the speech synthesis model to obtain a sample intermediate acoustic feature, the first-layer sub-model being configured to embed the sample semantic feature into the sample acoustic feature, and the sample intermediate acoustic feature being configured to represent a feature obtained by embedding the sample semantic feature into the sample acoustic feature; and the feature processing module being configured to input the sample intermediate acoustic feature into a second-layer sub-model in the speech synthesis model to obtain an audio synthesis feature, the second-layer sub-model being configured to synthesize the audio synthesis feature based on the sample intermediate acoustic feature, and the audio synthesis feature being configured to represent a feature corresponding to the to-be-synthesized target audio; a generation module, configured to generate, based on the audio synthesis feature, synthesized audio having a same timbre as the sample reference speech; a calculation module, configured to calculate a training loss of the speech synthesis model based on the sample audio and the synthesized audio; and an update module, configured to update model parameters of the speech synthesis model according to the training loss.

According to another aspect of this disclosure, a computer device is provided, including processing circuitry (e.g., a processor) and a memory, the memory including a non-transitory computer-readable storage medium having at least one computer program stored therein, and the at least one computer program being loaded and executed by the processor to implement the speech synthesis method according to the foregoing aspect or the method for training a speech synthesis model according to the foregoing aspect.

According to another aspect of this disclosure, a non-transitory computer-readable storage medium is provided, having at least one computer program stored therein, the at least one computer program being loaded and executed by processing circuitry (e.g., a processor) to implement the speech synthesis method according to the foregoing aspect or the method for training a speech synthesis model according to the foregoing aspect.

According to another aspect of this disclosure, a computer program product is provided, including a computer program. The computer program is stored in a non-transitory computer-readable storage medium. Processing circuitry (e.g., a processor) of a computer device reads the computer program from the non-transitory computer-readable storage medium and executes the computer program to cause the computer device to perform the speech synthesis method according to the foregoing aspect or the method for training a speech synthesis model according to the foregoing aspect.

The technical solutions provided in this disclosure may have at least the following beneficial effects.

The semantic feature and the acoustic feature corresponding to the reference speech are acquired. The semantic feature and the acoustic feature are inputted into the first-layer sub-model in the speech synthesis model to perform feature embedding, to obtain the intermediate acoustic feature. The intermediate acoustic feature is inputted into the second-layer sub-model in the speech synthesis model to perform speech synthesis, to obtain the audio synthesis feature. The audio synthesis feature is decoded to obtain the synthesized audio having the same timbre as the reference speech. In this disclosure, the semantic feature and the acoustic feature are processed through two layers of sub-models in the speech synthesis model, so that the finally generated audio synthesis feature can not only learn the semantic feature, but also fully learn the acoustic feature. Compared with a method based on imitation of real speech, sound outputted by the speech synthesis model based on this disclosure better conforms to actual sound production characteristics of an object corresponding to the selected timbre, thereby improving the authenticity of speech synthesis.

### BRIEF DESCRIPTION OF THE DRAWINGS

FIG. 1 is a schematic diagram of a speech synthesis method according to an embodiment of this disclosure.

FIG. 2 is a schematic architectural diagram of a computer system according to an embodiment of this disclosure.

FIG. 3 is a flowchart of a speech synthesis method according to an embodiment of this disclosure.

FIG. 4 is a flowchart of a speech synthesis method according to an embodiment of this disclosure.

FIG. 5 is a schematic diagram of acquiring an intermediate acoustic feature according to an embodiment of this disclosure.

FIG. 6 is a schematic diagram of acquiring an audio synthesis feature according to an embodiment of this disclosure.

FIG. 7 is a framework diagram of training system generation of a speech synthesis model and training of the speech synthesis model according to an embodiment of this disclosure.

FIG. 8 is a flowchart of a method for training a speech synthesis model according to an embodiment of this disclosure.

FIG. 9 is a flowchart of a method for training a speech synthesis model according to an embodiment of this disclosure.

FIG. 10 is a block diagram of a speech synthesis apparatus according to an embodiment of this disclosure.

FIG. 11 is a block diagram of an apparatus for training a speech synthesis model according to an embodiment of this disclosure.

FIG. 12 is a schematic structural diagram of a computer device according to an embodiment of this disclosure.

### DESCRIPTION OF EMBODIMENTS

To describe the objectives, technical solutions, and advantages of this disclosure, implementations of this disclosure will be described below with reference to the accompanying drawings. When the following description involves the accompanying drawings, unless otherwise indicated, the same numerals in different accompanying drawings represent the same or similar elements. The implementations described in the following embodiments do not represent all implementations consistent with this disclosure. On the contrary, the implementations are merely non-limiting examples of this disclosure. Other embodiments are within the scope of this disclosure.

The terms used in the present disclosure are merely non-limiting examples, and are not intended to limit the present disclosure. As used in the present disclosure and the appended claims, the singular forms “a”, “the”, and “this” are intended to include the plural forms as well, unless the context indicates otherwise. The term “and/or” as used herein refers to and encompasses any or all possible combinations of one or more of the associated listed items.

Although the terms such as “first”, “second”, and “third” may be used in the present disclosure to describe various information, the information is not to be limited to these terms. These terms are merely intended to distinguish information of the same type.

The use of “at least one of” or “one of” in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In some examples, the description of “a feature” in this disclosure may correspond to a feature map or a set of feature values.

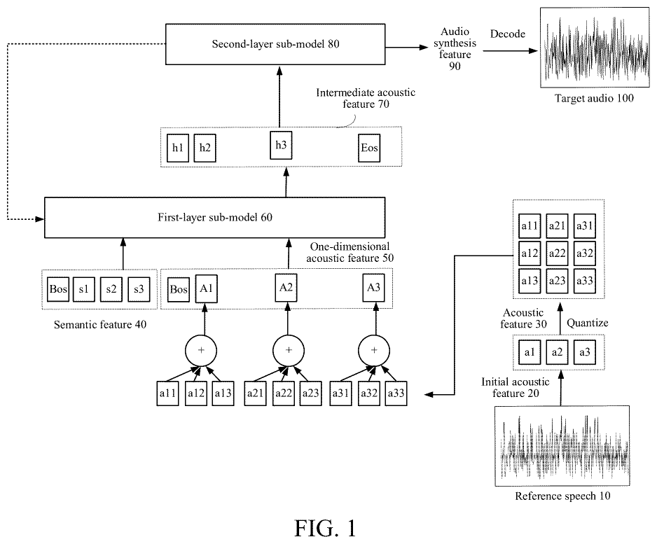

FIG. 1 is a schematic diagram of a speech synthesis method according to an embodiment of this disclosure. In some examples, the method may be performed by a computer device. The computer device may be a terminal or a server, and is provided with a speech synthesis model.

In some example, the computer device acquires a semantic feature and an acoustic feature; inputs the semantic feature and the acoustic feature into a first-layer sub-model in the speech synthesis model to obtain an intermediate acoustic feature, the first-layer sub-model being configured to embed the semantic feature into the acoustic feature; inputs the intermediate acoustic feature into a second-layer sub-model in the speech synthesis model to obtain an audio synthesis feature, the second-layer sub-model being configured to synthesize the audio synthesis feature based on the intermediate acoustic feature; and obtains, based on the audio synthesis feature, target audio conforming to a timbre of reference speech.

The semantic feature is configured to represent a feature of semantic information corresponding to to-be-synthesized target audio. In some examples, the semantic feature is configured to represent a feature of text information corresponding to the to-be-synthesized target audio.

In some embodiments, a mode for acquiring the semantic feature includes, but is not limited to, at least one of the following:
performing speech recognition on a speech signal corresponding to target audio to obtain text content; and performing feature extraction on the text content to obtain the semantic feature; and
performing text recognition and feature extraction on text in the text content to obtain the semantic feature, where in some embodiments, the text content includes at least one of a phrase, a sentence, a paragraph, and a chapter that include text and/or symbols; in some embodiments, a language type of the text content is not limited to Chinese and English, and may be any one or more languages; and
directly performing feature extraction on the speech signal to obtain the semantic feature configured to represent semantics of the speech signal.

The acoustic feature is a feature of acoustic information corresponding to the reference speech.

In some embodiments, the acoustic feature includes at least one of a recording environment feature, a timbre feature, and a prosodic duration feature, but is not limited thereto. This is not limited in this disclosure.

The recording environment feature is configured to represent a feature of a reference speech recording environment. The timbre feature is configured to represent a timbre feature of an object corresponding to a selected timbre. The prosodic duration feature is configured to represent a prosodic feature in the reference speech. For example, the prosodic duration feature is configured to represent a feature such as a tone, a length, and a pitch of the object corresponding to the selected timbre when the object speaks. In some examples, the prosodic duration feature is configured to represent a feature of cadence of the object corresponding to the selected timbre when the object speaks.

The reference speech refers to speech of the object corresponding to the selected timbre.

In some embodiments, the reference speech is the speech of the object corresponding to the selected timbre. In some examples, the reference speech is speech of the object corresponding to the selected timbre when the object reads text. In some examples, the reference speech is a segment of audio containing sound of the object corresponding to the selected timbre, but is not limited thereto. For example, the reference speech is a recording of a person A when the person A reads a piece of text.

The intermediate acoustic feature is configured to represent a feature obtained by embedding the semantic feature into the acoustic feature.

The audio synthesis feature is configured to represent a feature corresponding to the target audio.

As shown in FIG. 1, the computer device acquires reference speech 10 and inputs the reference speech 10 into an acoustic feature extraction network for feature extraction to obtain an initial acoustic feature 20. The computer device quantizes the initial acoustic feature 20 to obtain an acoustic feature 30. The initial acoustic feature 20 before quantization is a one-dimensional feature, and the quantized acoustic feature 30 is a multi-dimensional feature.

The initial acoustic feature 20 refers to a continuous feature extracted from the reference speech 10.

For example, the initial acoustic feature 20 before quantization may be represented as [a1, a2, a3], and the quantized acoustic feature 30 is a three-dimensional feature, which may be represented as:

$$[ \begin{matrix}a 11 & a 21 & a 31 \\ a 12 & a 22 & a 32 \\ a 13 & a 23 & a 33\end{matrix} ] .$$

In some examples, the number of dimensions of the feature refers to the number of rows of the feature that is arranged in a matrix form.

After obtaining the quantized acoustic feature 30, the computer device adds feature values in a same column in the acoustic feature 30 to obtain a one-dimensional acoustic feature 50; concatenates a semantic feature 40 and the one-dimensional acoustic feature 50 to obtain a concatenated feature, the concatenated feature referring to a feature obtained by concatenating the semantic feature 40 and the one-dimensional acoustic feature 50; and inputs the concatenated feature into a first-layer sub-model 60 to obtain an intermediate acoustic feature 70.

For example, the computer device adds feature values in a first column in the acoustic feature 30. For example, values of a11, a12, and a13 are added to obtain a first acoustic feature value A1 in the one-dimensional acoustic feature 50. Similarly, values of a21, a22, and a23 are added to obtain a second acoustic feature value A2 in the one-dimensional acoustic feature 50. Values of a31, a32, and a33 are added to obtain a third acoustic feature value A3 in the one-dimensional acoustic feature 50. Therefore, the obtained one-dimensional acoustic feature 50 may be represented as [A1, A2, A3].

In some embodiments, the semantic feature 40 may be represented as [s1, s2, s3]. The computer device concatenates the semantic feature 40 and the one-dimensional acoustic feature 50 to obtain the concatenated feature, and the obtained concatenated feature may be represented as [Bos, s1, s2, s3, Bos, A1, A2, A3], where Bos is configured to represent a beginning-of-sequence token. The computer device inputs the concatenated feature into the first-layer sub-model 60 to obtain a first intermediate acoustic feature value h1 in the intermediate acoustic feature 70. The computer device inputs a first audio synthesis feature value corresponding to the generated first intermediate acoustic feature value h1 and the concatenated feature into the first-layer sub-model 60 to predict an intermediate acoustic feature value, to obtain a second intermediate acoustic feature value h2. The first audio synthesis feature value is obtained through prediction by inputting the first intermediate acoustic feature value into a second-layer sub-model 80. The rest may be deduced by analogy until a quantity of outputted intermediate acoustic feature values is equal to a quantity of feature values in the one-dimensional acoustic feature. The computer device combines the generated intermediate acoustic feature values to obtain the intermediate acoustic feature 70, which may be represented as [h1, h2, h3, Eos], where Eos is configured to represent an end-of-sequence token.

After obtaining the intermediate acoustic feature 70, the computer device sequentially inputs the intermediate acoustic feature values in the intermediate acoustic feature 70 into the second-layer sub-model 80 to predict an audio synthesis feature value in an audio synthesis feature 90, to obtain the audio synthesis feature 90. The computer device decodes the audio synthesis feature 90 to obtain synthesized audio 100 having the same timbre as the reference speech 10.

In some embodiments, the computer device inputs the first intermediate acoustic feature value h1 in the intermediate acoustic feature 70 into the second-layer sub-model 80 to predict an audio synthesis feature value in the audio synthesis feature 90, to obtain a first audio synthesis feature value in the audio synthesis feature 90; inputs the generated first audio synthesis feature value and the concatenated feature into the first-layer sub-model 60 to obtain the second intermediate acoustic feature value h2; and inputs the generated second intermediate acoustic feature value h2 into the second-layer sub-model 80 to perform speech synthesis, to obtain a second audio synthesis feature value in the audio synthesis feature 90. The rest may be deduced by analogy until no intermediate acoustic feature value is inputted into the second-layer sub-model 80. The computer device combines the generated audio synthesis feature values to obtain the audio synthesis feature 90.

In summary, according to the method provided in this embodiment, the semantic feature and the acoustic feature corresponding to the reference speech are acquired. The semantic feature and the acoustic feature are inputted into the first-layer sub-model in the speech synthesis model to perform feature embedding, to obtain the intermediate acoustic feature. The intermediate acoustic feature is inputted into the second-layer sub-model in the speech synthesis model to perform speech synthesis, to obtain the audio synthesis feature. The audio synthesis feature is decoded to obtain the target audio conforming to the timbre of the reference speech. In this disclosure, the semantic feature and the acoustic feature are processed through two layers of sub-models in the speech synthesis model, so that the finally generated audio synthesis feature can not only learn the semantic feature, but also fully learn the acoustic feature. Compared with a method involving crude imitation of real speech, sound outputted by the speech synthesis model in this method better conforms to actual sound production characteristics of the object corresponding to the selected timbre, thereby improving the authenticity of speech synthesis.

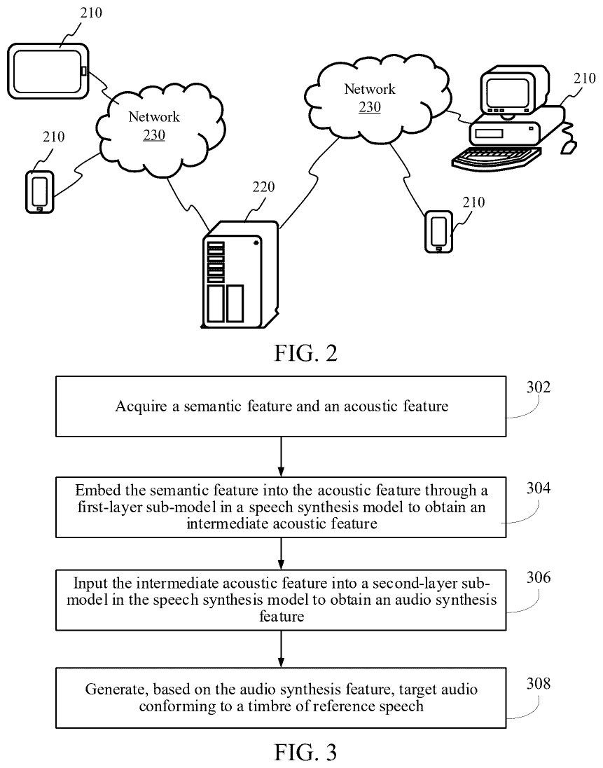

FIG. 2 is a schematic architectural diagram of a computer system according to an embodiment of this disclosure. The computer system may include a terminal 210 and a server 220.

The terminal 210 may be an electronic device such as a mobile phone, a tablet computer, an in-vehicle terminal (in-vehicle infotainment), a wearable device, a personal computer (PC), an aerial vehicle, or a self-service vending terminal. A client running a target application (App) may be installed in the terminal 210. The target App may be an App of reference speech synthesis or another App providing a speech synthesis function. This is not limited in this disclosure. In addition, the form of the target App is not limited in this disclosure. The target App includes, but is not limited to, an App, a mini program, or the like installed in the terminal 210, or may be in the form of a web page.

The server 220 may be an independent physical server, may be a server cluster or a distributed system including a plurality of physical servers, or may be a cloud server that provides basic cloud computing services such as a cloud database, cloud computing, a cloud function, cloud storage, a network service, cloud communication, a middleware service, a domain name service, a security service, a content delivery network (CDN), and big data. The server 220 may be a backend server of the target App, and is configured to provide a backend service for a client of the target App.

The terminal 210 and the server 220 may communicate with each other through a network 230, for example, a wired or wireless network.

In the speech synthesis method and the method for training a speech synthesis model provided in the embodiments of this disclosure, operations may be performed by a computer device. The computer device refers to an electronic device having data computing, processing, and storage capabilities. The solution implementation shown in FIG. 2 is taken as an example. The speech synthesis method and the method for training a speech synthesis model may be performed by the terminal 210 (for example, the client running the target App installed in the terminal 210 performs the speech synthesis method and the method for training a speech synthesis model), or by the server 220, or jointly by the terminal 210 and the server 220 in cooperation. This is not limited in this disclosure.

FIG. 3 is a flowchart of a speech synthesis method according to an embodiment of this disclosure. The method may be performed by a computer device. The computer device may be a terminal or a server, and is provided with a speech synthesis model. The method includes the following operations.

### Operation 302: Acquire a Semantic Feature and an Acoustic Feature.

The semantic feature is configured to represent semantic information corresponding to to-be-synthesized target audio. In some examples, the semantic feature is configured to represent text information corresponding to the to-be-synthesized target audio. In some examples, a semantic feature of text information that corresponds to content of to-be-synthesized target audio is acquired, and an acoustic feature of reference speech that corresponds to a target timbre of the to-be-synthesized target audio is acquired.

In some embodiments, a mode for acquiring the semantic feature includes: performing speech recognition on a speech signal corresponding to target audio to obtain text content; and performing feature extraction on the text content to obtain the semantic feature; or performing text recognition and feature extraction on text in the text content to obtain the semantic feature; or directly performing feature extraction on the speech signal to obtain the semantic feature configured to represent semantics of the speech signal.

In some embodiments, the text content includes at least one of a phrase, a sentence, a paragraph, and a chapter that include text and/or symbols. In some embodiments, a language type of the text content is not limited to Chinese and English, and may be any one or more languages.

The acoustic feature is configured to represent acoustic information corresponding to the reference speech.

In some embodiments, the acoustic feature includes at least one of a recording environment feature, a timbre feature, and a prosodic duration feature, but is not limited thereto. This is not limited in this disclosure.

The recording environment feature is configured to represent a feature of a reference speech recording environment. The timbre feature is configured to represent a timbre feature of an object corresponding to a selected timbre. The prosodic duration feature is configured to represent a prosodic feature in the reference speech. For example, the prosodic duration feature is configured to represent a feature such as a tone, a length, and a pitch of the object corresponding to the selected timbre when the object speaks. In some examples, the prosodic duration feature is configured to represent a feature of cadence of the object corresponding to the selected timbre when the object speaks.

The reference speech refers to speech of the object corresponding to the selected timbre. The object may be a physical object, for example, a specified user, or may be a virtual object, for example, an intelligent speech assistant, or a virtual role in a game. This is not limited in this disclosure.

In some embodiments, the reference speech is the speech of the object corresponding to the selected timbre. In some examples, the reference speech is speech of the object corresponding to the selected timbre when the object reads text. In some examples, the reference speech is a segment of audio containing sound of the object corresponding to the selected timbre, but is not limited thereto. For example, the reference speech is a recording of a person A when the person A reads a piece of text.

In some embodiments, the reference speech may be speech with a length of 3 seconds.

In some embodiments, the acoustic feature may be obtained by feature extraction through an acoustic encoder (which may also be referred to as an acoustic feature extraction network) in a speech synthesis model.

In some embodiments, the acoustic encoder may be implemented by a convolutional neural network (CNN), a transformer neural network, or a convolution-enhanced transformer network (Conformer). For example, the acoustic encoder may be implemented using a four-layer transformer neural network. In this disclosure, the acquisition of the acoustic feature is not limited to this implementation.

In some embodiments, the semantic feature may be obtained by feature extraction through a semantic encoder in the speech synthesis model.

In some embodiments, the semantic encoder may be implemented by a self-supervised learning (SSL) encoder and a k-means clustering algorithm. In this disclosure, the acquisition of the semantic feature is not limited to this implementation.

In some embodiments, the computer device may concatenate the reference speech and the speech signal corresponding to the target audio to obtain a concatenated speech signal. The computer device performs feature extraction on the concatenated speech signal to obtain the semantic feature and the acoustic feature.

In some embodiments, reference speech of a first time length and a speech signal corresponding to target audio of a second time length are acquired. The computer device concatenates the reference speech and the speech signal corresponding to the target audio to obtain the concatenated speech signal; performs feature extraction on the reference speech of the first time length through the acoustic feature extraction network to obtain the acoustic feature; and performs feature extraction on the speech signal corresponding to the target audio of the second time length through a semantic feature extraction network to obtain the semantic feature.

For example, 3-second reference speech and a 7-second speech signal corresponding to target audio are acquired. The computer device concatenates the 3-second reference speech and the 7-second speech signal to obtain a 10-second concatenated speech signal; performs feature extraction on the 3-second reference speech through the acoustic feature extraction network to obtain the acoustic feature; and performs feature extraction on the 7-second speech signal through the semantic feature extraction network to obtain the semantic feature. The computer device finally obtains the synthesized audio based on the semantic feature and the acoustic feature, that is, the synthesized audio can be expressed using the speech of the object corresponding to the selected timbre through brief 3-second reference speech. For example, if a person A wants to imitate a person B to read an article, it is only necessary to acquire 3-second speech of the person B as reference speech and a speech signal of the person A reading an article. The computer device concatenates the 3-second speech of the person B and the speech signal of the person A reading an article, and then inputs the concatenated content into the speech synthesis model provided in this disclosure to obtain that the person A reads an article using the sound of the person B.

Operation 304: Embed the Semantic Feature into the Acoustic Feature Through a First-Layer Sub-Model in the Speech Synthesis Model to Obtain an Intermediate Acoustic Feature.

The intermediate acoustic feature is a feature obtained by embedding the semantic feature into the acoustic feature. In some examples, an intermediate acoustic feature is obtained by processing circuitry through a first-layer sub-model in a speech synthesis model, the first-layer sub-model being configured to output feature values of the intermediate acoustic feature based on the semantic feature and the acoustic feature.

Embedding the semantic feature into the acoustic feature refers to enabling the acoustic feature to learn semantic information or text information in the semantic feature through the first-layer sub-model, that is, to acquire text information that the target audio wants to express.

The speech synthesis model includes a first-layer sub-model and a second-layer sub-model. The first-layer sub-model and the second-layer sub-model may have the same model structure, but at least one of network parameters, execution tasks, and quantities of network layers thereof are different.

The first-layer sub-model is configured to embed the semantic feature into the acoustic feature.

In some embodiments, the first-layer sub-model may adopt at least one of an attention network Transformer, a pre-trained language representation model—bidirectional encoder representation from transformers (BERT), and a recurrent neural network (RNN), but is not limited thereto. This is not limited in this disclosure.

Operation 306: Input the Intermediate Acoustic Feature into the Second-Layer Sub-Model in the Speech Synthesis Model to Obtain an Audio Synthesis Feature.

The audio synthesis feature is a feature corresponding to the target audio.

The second-layer sub-model is configured to synthesize the audio synthesis feature based on the intermediate acoustic feature. In some examples, an audio synthesis feature is obtained by the processing circuitry through a second-layer sub-model in the speech synthesis model, the second-layer sub-model being configured to output feature values of the audio synthesis feature based on the intermediate acoustic feature.

In some embodiments, the second-layer sub-model may adopt at least one of an attention network Transformer, a BERT, or an RNN, but is not limited thereto. This is not limited in this disclosure.

### Operation 308: Generate, Based on the Audio Synthesis Feature, Target Audio Conforming to the Timbre of the Reference Speech.

The target audio is audio that imitates the sound of the object (human voice in the reference speech) corresponding to the selected timbre to speak the text information that the target audio intends to express. In the generated target audio, the timbre of the expressed sound conforms to the timbre expressed by the object in the reference speech. Conforming may be understood as the timbre of the text information expressed in the target audio being the same as or similar to the timbre expressed by the object in the reference audio.

In some examples, the computer device decodes the audio synthesis feature to obtain the target audio conforming to the timbre of the reference speech, that is, to obtain the synthesized audio in which the text information is expressed using the human voice of the reference speech.

In summary, according to the method provided in this embodiment, the semantic feature and the acoustic feature corresponding to the reference speech are acquired. The semantic feature and the acoustic feature are inputted into the first-layer sub-model in the speech synthesis model to perform feature embedding, to obtain the intermediate acoustic feature. The intermediate acoustic feature is inputted into the second-layer sub-model in the speech synthesis model to perform speech synthesis, to obtain the audio synthesis feature. The audio synthesis feature is decoded to obtain the target audio conforming to the timbre of the reference speech. In this disclosure, the semantic feature and the acoustic feature are processed through two layers of sub-models in the speech synthesis model, so that the finally generated audio synthesis feature can not only learn the semantic feature, but also fully learn the acoustic feature. Compared with a method involving crude imitation of real speech, sound outputted by the speech synthesis model in this method better conforms to actual sound production characteristics of the object corresponding to the selected timbre, thereby improving the authenticity of speech synthesis.

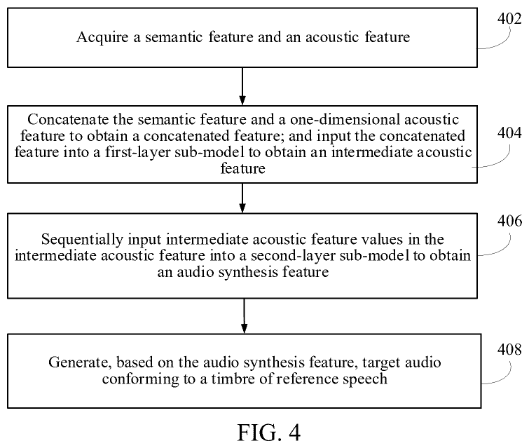

FIG. 4 is a flowchart of a speech synthesis method according to an embodiment of this disclosure. The method may be performed by a computer device. The computer device may be a terminal or a server, and is provided with a speech synthesis model. The method includes the following operations.

### Operation 402: Acquire a Semantic Feature and an Acoustic Feature.

The semantic feature is configured to represent semantic information corresponding to target audio. In some examples, the semantic feature is configured to represent text information corresponding to the target audio.

The acoustic feature is a feature of acoustic information corresponding to the reference speech. The acoustic feature may represent sound production characteristics and reading characteristics of an object corresponding to a selected timbre, characteristics of a reference speech recording environment, or the like.

In some embodiments, the computer device acquires the reference speech, and inputs the reference speech into an acoustic feature extraction network in the speech synthesis model for feature extraction to obtain the acoustic feature.

In some embodiments, the computer device inputs the reference speech into the acoustic feature extraction network for feature extraction to obtain an initial acoustic feature. The computer device quantizes the initial acoustic feature to obtain the acoustic feature.

In some embodiments, the computer device performs Fourier transform on a speech signal corresponding to each time granularity in the reference speech to obtain a mel-spectrogram corresponding to the reference speech; inputs the mel-spectrogram into the acoustic feature extraction network for feature extraction to obtain an initial acoustic feature; and quantizes the initial acoustic feature to obtain the acoustic feature.

The initial acoustic feature refers to a continuous feature extracted from the reference speech.

Since the initial acoustic feature is a continuous feature, for ease of subsequent calculation, the initial acoustic feature needs to be quantized, to obtain the acoustic feature. The initial acoustic feature before quantization is a one-dimensional feature, and the quantized acoustic feature is a K-dimensional feature, K being a positive integer greater than 1. The quantized acoustic feature has higher expressiveness than the initial acoustic feature before quantization, that is, a multi-dimensional feature can more fully represent the acoustic feature.

For example, the initial acoustic feature before quantization may be represented as [a1, a2, a3], and the quantized acoustic feature is a three-dimensional feature, which may be represented as:

$$[ \begin{matrix}a 11 & a 21 & a 31 \\ a 12 & a 22 & a 32 \\ a 13 & a 23 & a 33\end{matrix} ] .$$

In some examples, the initial acoustic feature is a one-dimensional feature that includes M initial feature values, M being a positive integer greater than two, and the acoustic feature is a multi-dimensional feature arranged in a matrix form that includes M columns and K rows of acoustic feature values, K being a positive integer greater than two. In some examples, the quantizing the initial acoustic feature includes quantizing an m-th initial feature value of the initial acoustic feature to obtain a first quantized acoustic feature value in an m-th column and a first row in the acoustic feature, m being a positive integer ranging from 1 to M; quantizing a first residual between the first quantized acoustic feature value and the m-th initial feature value to obtain a second quantized acoustic feature value in the m-th column and a second row in the acoustic feature; and quantizing a k-th residual between a k-th quantized acoustic feature value and a (k−1)-th quantized acoustic feature value to obtain a (k+1)-th quantized acoustic feature value in the m-th column and (k+1)-th row in the acoustic feature, k being a positive integer ranging from 2 to (K−1).

In some examples, the operation of quantizing the initial acoustic feature to the acoustic feature includes: quantizing, by the computer device, an m^{th} acoustic feature value in the initial acoustic feature to obtain a first quantized acoustic feature value in an m^{th} column in the acoustic feature, m being a positive integer; quantizing, by the computer device, a residual between the first quantized acoustic feature value and the m^{th} acoustic feature value to obtain a second quantized acoustic feature value in the m^{th} column; quantizing, by the computer device, a residual between a kth quantized acoustic feature value and a (k−1)^{th} quantized acoustic feature value to obtain a (k+1)^{th} quantized acoustic feature value in the m^{th} column, k being a positive integer greater than 1; combining, by the computer device, a11 quantized acoustic feature values obtained through quantization in the m^{th} column dimension to obtain a quantized acoustic feature value of the m^{th} column in the acoustic feature; and repeating the foregoing operations, and combining quantized acoustic feature values of columns to obtain the acoustic feature.

For example, the computer device quantizes a first acoustic feature value a1 in the initial acoustic feature to obtain a first quantized acoustic feature value a11 in a first column in the acoustic feature; quantizes a residual between the first acoustic feature value a1 and the first quantized acoustic feature value a11 in the first column to obtain a second quantized acoustic feature value a12 in the first column; quantizes a residual between the second quantized acoustic feature value a12 and the first quantized acoustic feature value a11 in the first column to obtain a third quantized acoustic feature value a13 in the first column; combines a11 quantized acoustic feature values in the first column to obtain an acoustic feature of the first column in the acoustic feature; performs the foregoing operations on the other columns to obtain acoustic features of the other columns in the acoustic feature; and combines quantized acoustic feature values of the columns to obtain the acoustic feature.

Based on a difference between adjacent quantized acoustic feature values in the same column, a next quantized acoustic feature value in the column is determined, so that not only a low-dimensional initial acoustic feature may be quickly extended to a high-dimensional acoustic feature, but also a context relationship in the reference speech may be effectively expressed in the acoustic feature, thereby improving the expression richness and quantization quality of the acoustic feature.

In some embodiments, a quantity of columns of the acoustic feature may be manually set as required.

In some embodiments, a mode for acquiring the reference speech includes at least one of the following cases.
1. The computer device receives the reference speech. For example, the terminal is a terminal initiating audio recording. Audio is recorded through the terminal and used as the reference speech after the recording ends.
2. The computer device acquires the reference speech from a stored database.

The foregoing examples for acquiring the reference speech are merely non-limiting examples. This is not limited in this disclosure.

Operation 404: Concatenate the Semantic Feature and a One-Dimensional Acoustic Feature to Obtain a Concatenated Feature; and Input the Concatenated Feature into a First-Layer Sub-Model to Obtain an Intermediate Acoustic Feature.

The concatenated feature refers to a feature obtained by concatenating the semantic feature and the one-dimensional acoustic feature. In some examples, a one-dimensional acoustic feature is obtained based on the acoustic feature, each feature value of the one-dimensional acoustic feature being based on a summation of feature values in each column of the acoustic feature. In some examples, the semantic feature and the one-dimensional acoustic feature are concatenated to obtain a concatenated feature as input of the first-layer sub-model.

The acoustic feature is a feature of acoustic information corresponding to the reference speech. The acoustic feature is a K-dimensional feature, K being a positive integer greater than 1.

In some examples, the computer device adds feature values in the same column in the acoustic feature to obtain the one-dimensional acoustic feature.

For example, the acoustic feature is a three-dimensional feature, which may be represented as:

$$[ \begin{matrix}a 11 & a 21 & a 31 \\ a 12 & a 22 & a 32 \\ a 13 & a 23 & a 33\end{matrix} ] .$$

The computer device adds feature values in a first column in the acoustic feature. For example, values of a11, a12, and a13 are added to obtain a first acoustic feature value A1 in the one-dimensional acoustic feature. Similarly, values of a21, a22, and a23 are added to obtain a second acoustic feature value A2 in the one-dimensional acoustic feature. Values of a31, a32, and a33 are added to obtain a third acoustic feature value A3 in the one-dimensional acoustic feature. Therefore, the obtained one-dimensional acoustic feature may be represented as [A1, A2, A3].

In some examples, the audio synthesis feature is obtained through the second-layer sub-model, including obtaining a first intermediate acoustic feature value of the intermediate acoustic feature through inputting the concatenated feature to the first-layer sub-model; and obtaining an i-th intermediate acoustic feature value of the intermediate acoustic feature through inputting an (i−1)-th audio synthesis feature value of the audio synthesis feature and the concatenated feature to the first-layer sub-model, the (i−1)-th audio synthesis feature value being obtained through inputting the (i−1)-th intermediate acoustic feature value of the intermediate acoustic feature into the second-layer sub-model. In these examples, the intermediate acoustic feature includes N intermediate acoustic feature values, N is a positive integer greater than two, and i is a positive integer ranging from 2 to N.

In some embodiments, the semantic feature may be represented as [s1, s2, s3]. The computer device concatenates the semantic feature and the one-dimensional acoustic feature to obtain the concatenated feature, and the obtained concatenated feature may be represented as [Bos, s1, s2, s3, Bos, A1, A2, A3], where Bos is configured to represent a beginning-of-sequence token. The computer device inputs the concatenated feature into the first-layer sub-model to predict an intermediate acoustic feature value in the intermediate acoustic feature, to obtain a first intermediate acoustic feature value in the intermediate acoustic feature; inputs an (i−1)^{th} audio synthesis feature value corresponding to an (i−1)^{th} intermediate acoustic feature value and the concatenated feature into the first-layer sub-model to predict an intermediate acoustic feature value, to obtain an i^{th} intermediate acoustic feature value, the (i−1)^{th} audio synthesis feature value being obtained through prediction by inputting the (i−1)^{th} intermediate acoustic feature value into the second-layer sub-model; repeats the previous operation until a quantity of outputted intermediate acoustic feature values is equal to a quantity, for example, N, of feature values in the one-dimensional acoustic feature; and combines N intermediate acoustic feature values to obtain the intermediate acoustic feature, i being a positive integer greater than 1.

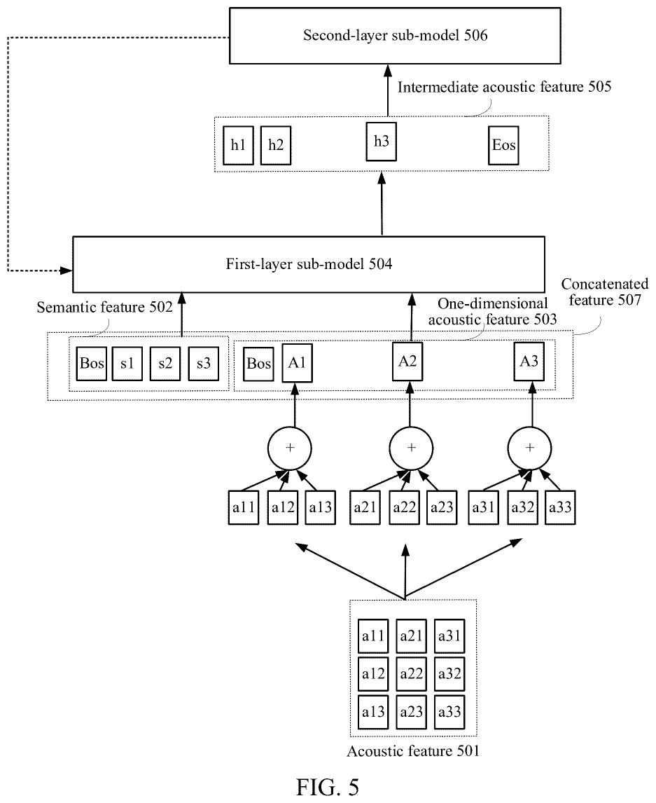

FIG. 5 is a schematic diagram of acquiring an intermediate acoustic feature. The computer device adds feature values in the same column in an acoustic feature 501 to obtain a one-dimensional acoustic feature 503. A semantic feature 502 may be represented as [s1, s2, s3]. The computer device concatenates the semantic feature 502 and the one-dimensional acoustic feature 503 to obtain a concatenated feature 507, and the obtained concatenated feature 507 may be represented as [Bos, s1, s2, s3, Bos, A1, A2, A3], where Bos is configured to represent a beginning-of-sequence token. The computer device inputs the concatenated feature 507 into a first-layer sub-model 504 to obtain a first intermediate acoustic feature value h1 in an intermediate acoustic feature 505. The computer device inputs a first audio synthesis feature value corresponding to the generated first intermediate acoustic feature value h1 and the concatenated feature 507 into the first-layer sub-model 504 to predict an intermediate acoustic feature value, to obtain a second intermediate acoustic feature value h2. The first audio synthesis feature value is obtained through prediction by inputting the first intermediate acoustic feature value h1 into a second-layer sub-model 506. The computer device inputs a second audio synthesis feature value corresponding to the generated second intermediate acoustic feature value h2 and the concatenated feature 507 into the first-layer sub-model 504 to predict an intermediate acoustic feature value, to obtain a third intermediate acoustic feature value h3. The second audio synthesis feature value is obtained through prediction by inputting the second intermediate acoustic feature value h2 into the second-layer sub-model 506. The rest may be deduced by analogy until a quantity of intermediate acoustic feature values outputted by the first-layer sub-model 504 is equal to a quantity of feature values in the one-dimensional acoustic feature 503. For example, the one-dimensional acoustic feature 503 may be represented as [Bos, A1, A2, A3], including three feature values. When the first-layer sub-model 504 outputs three intermediate acoustic feature values, the first-layer sub-model 504 ends prediction. The computer device combines the generated intermediate acoustic feature values to obtain the intermediate acoustic feature 505, which may be represented as [h1, h2, h3, Eos].

The generated audio synthesis feature value is fed back to the stage of determining the intermediate acoustic feature value, so that the accuracy of determining the intermediate acoustic feature may be improved, and the expression capability of the intermediate acoustic feature value may be improved.

The speech synthesis model includes a first-layer sub-model and a second-layer sub-model. The first-layer sub-model and the second-layer sub-model may have the same model structure, but at least one of network parameters, execution tasks, and quantities of network layers thereof are different.

The first-layer sub-model is configured to embed the semantic feature into the acoustic feature.

In some embodiments, the first-layer sub-model may adopt at least one of an attention network Transformer, a pre-trained language representation model-BERT, and an RNN, but is not limited thereto. This is not limited in this disclosure.

Semantic feature values in the semantic feature are discrete numbers. For ease of calculation of the first-layer sub-model, mathematical processing needs to be performed on the semantic feature values to convert the semantic feature values into vectors. A formula for vectorization processing of the semantic feature may be represented as:

$$E ( {s}_{t 1} ) = {E}_{s} ( {s}_{t 1} ) + {PE}_{g} ( t ) ,$$

where E(sₜ₁) refers to a vectorized semantic feature, sₜ₁ refers to a semantic feature value, Eₛ is an embedding function used for the semantic feature value, PE_{g} is used for representing a position embedding function of the first-layer sub-model, t1 is used for representing a time point or a time position, 1≤t1≤T₁, and T₁ is used for representing a time length corresponding to the semantic feature.

Similarly, acoustic feature values in the one-dimensional acoustic feature are discrete numbers. For ease of calculation of the first-layer sub-model, mathematical processing needs to be performed on the one-dimensional acoustic feature to convert the one-dimensional acoustic feature into a vector. A formula for vectorization processing of the one-dimensional acoustic feature may be represented as:

$$E ( {a}_{t 2} ) = {\sum }_{q = 1}^{D} {E}_{s} ( {a}_{t 2}^{q} ) + {PE}_{g} ( t 2 + {T}_{1} ) ,$$

refers where E(aₜ₂) refers to a vectorized one-dimensional acoustic feature,

$${a}_{t 2}^{q}$$

refers to an acoustic feature value,

$${\sum }_{q = 1}^{D} {E}_{s} ( {a}_{t 2}^{q} )$$

refers to a one-dimensional acoustic feature value, Eₛ is an embedding function used for the acoustic feature value, PE_{g} is used for representing the position embedding function of the first-layer sub-model, t2 is used for representing a time point or a time position, 1≤t2≤T₂, and T2 is used for representing a time length corresponding to the one-dimensional acoustic feature.

A calculation formula of the first-layer sub-model may be represented as:

$${h}_{t} = GlobalTransformer ( E ( {s}_{t 1} ) , E ( {a}_{t 2} ) ) = GlobalTransformer ( {s}_{1} , ... , {s}_{T 1} , {a}_{1} , ... , {a}_{T 2} ) ,$$

where E(sₜ₁) refers to a vectorized semantic feature, E(aₜ₂) refers to a vectorized one-dimensional acoustic feature, hₜ refers to an intermediate acoustic feature, and GlobalTransformer is used for representing the first-layer sub-model, 1≤t≤T₁+T₂.
   Operation 406: Sequentially Input Intermediate Acoustic Feature Values in the Intermediate Acoustic Feature into the Second-Layer Sub-Model to Obtain an Audio Synthesis Feature.

The audio synthesis feature is configured to represent a feature corresponding to the target audio.

The second-layer sub-model is configured to synthesize the audio synthesis feature based on the acoustic feature. In some examples, intermediate acoustic feature values of the intermediate acoustic feature are sequentially inputted into the second-layer sub-model to obtain respective audio synthesis feature values of the audio synthesis feature.

In some embodiments, the second-layer sub-model may adopt at least one of an attention network Transformer, a BERT, or an RNN, but is not limited thereto. This is not limited in this disclosure.

In some examples, the computer device sequentially inputs the intermediate acoustic feature values in the intermediate acoustic feature into the second-layer sub-model to obtain the audio synthesis feature.

In some examples, the method includes providing a (j−1)-th audio synthesis feature value of the audio synthesis feature value to the first-layer sub-model that is configured to output a j-th intermediate acoustic feature value of the intermediate acoustic feature based on the semantic feature, the acoustic feature, and the (j−1)-th audio synthesis feature value. In these examples, the intermediate acoustic feature includes N intermediate acoustic feature values, Nis a positive integer greater than two, and j is a positive integer ranging from 2 to N.

In some examples, the computer device inputs a first intermediate acoustic feature value in the intermediate acoustic feature into the second-layer sub-model to obtain a first audio synthesis feature value in the audio synthesis feature through prediction, the audio synthesis feature value referring to a feature value in the audio synthesis feature; inputs a j^{th} intermediate acoustic feature value generated by a (j−1)^{th} audio synthesis feature value into the second-layer sub-model to obtain a j^{th} audio synthesis feature value through prediction, the j^{th} intermediate acoustic feature value being obtained through prediction by inputting the (j−1)^{th} audio synthesis feature value into the first-layer sub-model; repeats a previous operation until a quantity of outputted audio synthesis feature values is equal to a quantity N of intermediate acoustic feature values in the intermediate acoustic feature; and combines N audio synthesis feature values to obtain the audio synthesis feature.

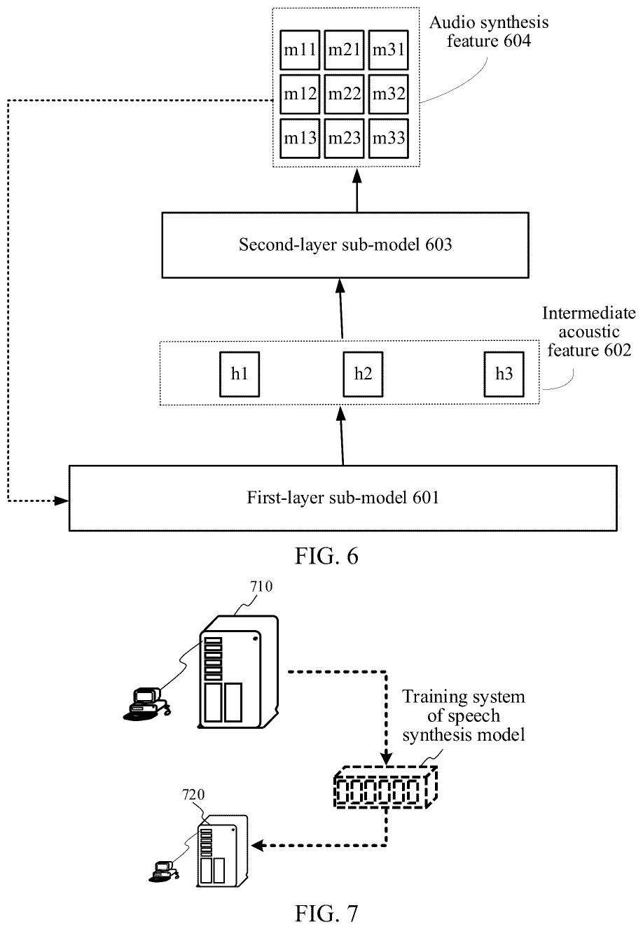

FIG. 6 is a schematic diagram of acquiring an audio synthesis feature. The computer device inputs a first intermediate acoustic feature value h1 in an intermediate acoustic feature 602 into a second-layer sub-model 603 to predict an audio synthesis feature value in an audio synthesis feature 604, to obtain a first audio synthesis feature value in the audio synthesis feature 604. The first audio synthesis feature value may be represented as: [m11, m12, m13]. The computer device inputs the generated first audio synthesis feature value and a concatenated feature into a first-layer sub-model 601 to obtain a second intermediate acoustic feature value h2. The computer device inputs the generated second intermediate acoustic feature value h2 into the second-layer sub-model 603 to predict an audio synthesis feature value, to obtain a second audio synthesis feature value. The second audio synthesis feature value may be represented as: [m21, m22, m23]. The computer device inputs the generated first audio synthesis feature value, the generated second audio synthesis feature value, and the concatenated feature into the first-layer sub-model 601 to obtain a third intermediate acoustic feature value h3. The computer device inputs the generated third intermediate acoustic feature value h3 into the second-layer sub-model 603 to predict an audio synthesis feature value, to obtain a third audio synthesis feature value. The third audio synthesis feature value may be represented as: [m31, m32, m33]. The rest may be deduced by analogy until a quantity of outputted audio synthesis feature values is equal to a quantity of intermediate acoustic feature values in the intermediate acoustic feature 602 or until no intermediate acoustic feature value is inputted into the second-layer sub-model 603. The computer device combines the generated audio synthesis feature values to obtain the audio synthesis feature 604.

Acoustic feature values in the acoustic feature to be inputted into the second-layer sub-model are discrete numbers. For ease of calculation of the second-layer sub-model, mathematical processing needs to be performed on the acoustic feature to convert the acoustic feature into a vector. A formula for vectorization processing of the acoustic feature may be represented as:

$$E ( {a}_{t}^{q} ) = {E}_{a} ( {a}_{t}^{q} ) + {PE}_{l} ( q ) ,$$

where

$$E ( {a}_{t}^{q} )$$

refers to a vectorized acoustic feature,

$${a}_{t}^{q}$$

refers to an acoustic feature value, 1≤q≤D, q is a dimension of the acoustic feature value, D is a total dimension of the acoustic feature, Eₐ is an embedding function used for the acoustic feature value, PEₜ is used for representing a position embedding function of the second-layer sub-model, and t is used for representing a time point or a time position.

A calculation formula of the second-layer sub-model may be represented as:

$${M}_{t} = LocalTransformer ( {h}_{t} , E ( {a}_{t}^{q} ) ) = LocalTransformer ( {h}_{t} , {a}_{t}^{1} , ... , {a}_{t}^{D} ) ,$$

where

$$E ( {a}_{t}^{q} )$$

refers to a vectorized feature, hₜ refers to an intermediate acoustic feature,

$${a}_{t}^{q}$$

refers to an acoustic feature value, and LocalTransformer is used for representing the second-layer sub-model, 1≤t≤T₂.

### Operation 408: Generate, Based on the Audio Synthesis Feature, Target Audio Conforming to the Timbre of the Reference Speech.

The synthesized audio is audio that imitates the sound of the object (human voice in the reference speech) corresponding to the selected timbre to speak to-be-expressed text information.

In some examples, the computer device decodes the audio synthesis feature to obtain the target audio whose timbre is the same as or similar to that of the reference speech, that is, to obtain synthesized audio expressed using the human voice of the reference speech.

In some embodiments, the audio synthesis feature may be obtained by feature decoding through a decoder in a speech synthesis model.

In some embodiments, the decoder may be implemented by a CNN, a transformer neural network, or a convolution-enhanced transformer network (Conformer). For example, the decoder may be implemented using a six-layer transformer neural network. In this disclosure, a structure of the decoder is not limited to this implementation.

To verify the synthesis effect of the speech synthesis method provided in the embodiments of this disclosure, this disclosure compares the synthesis effect of the speech synthesis model provided in the embodiments of this disclosure with the synthesis effect of a model in the related art. Evaluation indicators selected in the embodiments of this disclosure include a word error rate (WER), speech similarity (SPK), and speech quality (DNSMOS). The synthesis advantages of the speech synthesis model provided in the embodiments of this disclosure are reflected through these three indicators. Comparison results of the synthesis effects of the speech synthesis models are shown in Table 1.

TABLE 1
Comparison results of synthesis effects of speech synthesis models

| Model | WER | Speech similarity | Speech quality |
|---|---|---|---|
| First group | | | |
| Related model 1 | 12.4 | | |
| Related model 2 | 6.0 | | |
| Speech synthesis model | 4.0 | | |
| Second group | | | |
| Related model 1 | 7.7 | 0.337 | 3.68 |
| Related model 2 | 5.9 | 0.580 | 3.87 |
| Speech synthesis model | 4.2 | 0.605 | 3.89 |
| Third group | | | |
| Related model 1 | 3.8 | 0.508 | |
| Speech synthesis model | 2.8 | 0.536 | |

There are three groups of experiments. The related model 1 and the related model 2 refer to models in the related art, and the speech synthesis model refers to the model provided in the embodiments of this disclosure. It may be learned from the table that speech or audio synthesized by the speech synthesis model has the lowest WER, the highest speech similarity, and the best speech quality.

In summary, according to the method provided in this embodiment, the semantic feature and the acoustic feature corresponding to the reference speech are acquired. The semantic feature and the acoustic feature are inputted into the first-layer sub-model in the speech synthesis model to perform feature embedding, to obtain the intermediate acoustic feature. The intermediate acoustic feature is inputted into the second-layer sub-model in the speech synthesis model to perform speech synthesis, to obtain the audio synthesis feature. The audio synthesis feature is decoded to obtain the synthesized audio having the same timbre as the reference speech. In this disclosure, the semantic feature and the acoustic feature are processed through two layers of sub-models in the speech synthesis model, so that the finally generated audio synthesis feature can not only learn the semantic feature, but also fully learn the acoustic feature. Compared with a method involving crude imitation of real speech, sound outputted by the speech synthesis model in this method better conforms to actual sound production characteristics of the object corresponding to the selected timbre, thereby improving the authenticity of speech synthesis.

According to the method provided in this embodiment, the semantic feature and the acoustic feature are embedded through the first-layer sub-model in the speech synthesis model, so that a to-be-expressed semantic feature and a to-be-imitated acoustic feature are fused, and actual sound production characteristics of the object corresponding to the selected timbre are generated based on the to-be-expressed semantic feature and the to-be-imitated acoustic feature, thereby improving the authenticity of speech synthesis.

According to the method provided in this embodiment, acoustic information of the intermediate acoustic feature outputted by the first-layer sub-model is restored through the second-layer sub-model in the speech synthesis model, and a restoration result is transmitted to the first-layer sub-model again for prediction, and the audio synthesis feature is finally obtained through cyclic prediction. The semantic feature and the acoustic feature are processed in a cyclic processing mode, so that the finally generated audio synthesis feature can not only learn the semantic feature, but also fully learn the acoustic feature. Compared with a method involving crude imitation of real speech, sound outputted by the speech synthesis model in this method better conforms to actual sound production characteristics of the object corresponding to the selected timbre, thereby improving the authenticity of speech synthesis.

According to the method provided in this embodiment, feature extraction and quantization are performed on the acquired reference speech, so that the acoustic feature can more fully represent the feature in acoustic aspects, and the sound of the speaker better conforms to actual sound production characteristics of the object corresponding to the selected timbre, thereby improving the authenticity of speech synthesis.

According to the method provided in this embodiment, the semantic feature and the acoustic feature are integrated through two layers of sub-models, thereby not only reducing the calculation cost, but also effectively learning an interaction relationship between the semantic feature and the acoustic feature.

The method for training a speech synthesis model according to this disclosure may be implemented based on a training system of the speech synthesis model. The solution includes a training system generation stage of the speech synthesis model and a training stage of the speech synthesis model. FIG. 7 is a framework diagram of training system generation of a speech synthesis model and training of the speech synthesis model according to an embodiment of this disclosure. As shown in FIG. 7, in the training system generation stage of the speech synthesis model, after a training system generation device 710 of the speech synthesis model obtains the training system of the speech synthesis model through a preset training sample data set, a training result of the speech synthesis model is generated based on the training system of the speech synthesis model. In the training stage of the speech synthesis model, a training device 720 of the speech synthesis model processes an inputted audio signal based on the training system of the speech synthesis model to obtain a training result of the speech synthesis model.

The training system generation device 710 of the speech synthesis model and the training device 720 of the speech synthesis model may be computer devices. For example, the computer devices may be fixed computer devices such as personal computers or servers. In some examples, the computer devices may be mobile computer devices such as tablet computers or e-book readers.

In some embodiments, the training system generation device 710 of the speech synthesis model and the training device 720 of the speech synthesis model may be the same device. In some examples, the training system generation device 710 of the speech synthesis model and the training device 720 of the speech synthesis model may be different devices. In addition, when the training system generation device 710 of the speech synthesis model and the training device 720 of the speech synthesis model are different devices, the training system generation device 710 of the speech synthesis model and the training device 720 of the speech synthesis model may be devices of the same type. For example, the training system generation device 710 of the speech synthesis model and the training device 720 of the speech synthesis model may both be servers. In some examples, the training system generation device 710 of the speech synthesis model and the training device 720 of the speech synthesis model may be different types of devices. For example, the training device 720 of the speech synthesis model may be a personal computer or a terminal, and the training system generation device 710 of the speech synthesis model may be a server or the like. Types of the training system generation device 710 of the speech synthesis model and the training device 720 of the speech synthesis model are not limited in this disclosure.

The speech synthesis method is described in the foregoing embodiments. A method for training a speech synthesis model is described below.

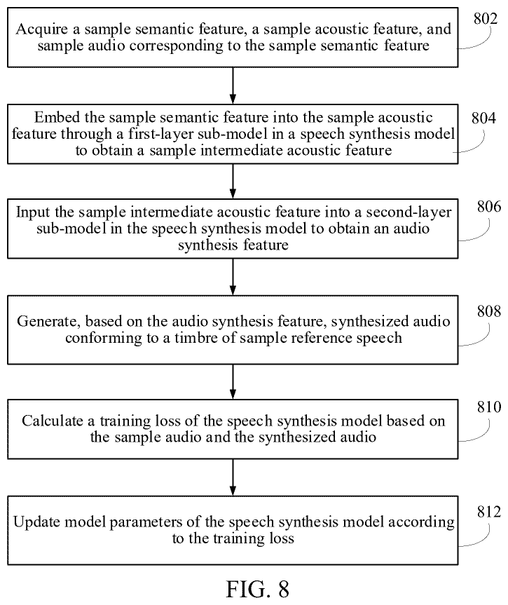

FIG. 8 is a flowchart of a method for training a speech synthesis model according to an embodiment of this disclosure. The method may be performed by a computer device. The computer device may be a terminal or a server, and is provided with a speech synthesis model. The method includes the following operations.

### Operation 802: Acquire a Sample Semantic Feature, a Sample Acoustic Feature, And Sample Audio Corresponding to the Sample Semantic Feature.

The sample semantic feature is configured to represent semantic information corresponding to the sample audio. In some examples, the sample semantic feature is configured to represent text information corresponding to the sample audio. In some examples, sample audio that corresponds to a reference timbre is acquired, a sample semantic feature of the sample audio is acquired, and a sample acoustic feature of sample reference speech that corresponds to the reference timbre is acquired.

In some embodiments, a mode for acquiring the sample semantic feature includes: performing speech recognition on a speech signal corresponding to the sample audio to obtain text content; and performing feature extraction on the text content to obtain the sample semantic feature; or performing text recognition and feature extraction on text in the text content to obtain the sample semantic feature; or directly performing feature extraction on the speech signal to obtain the sample semantic feature configured to represent semantics of the speech signal.

In some embodiments, the text content includes at least one of a phrase, a sentence, a paragraph, and a chapter that include text and/or symbols. In some embodiments, a language type of the text content is not limited to Chinese and English, and may be any one or more languages.

The sample acoustic feature is a feature of acoustic information corresponding to the sample reference speech.

In some embodiments, the sample acoustic feature includes at least one of a recording environment feature, a timbre feature, and a prosodic duration feature, but is not limited thereto. This is not limited in this disclosure.

The recording environment feature is configured to represent a feature of a sample reference speech recording environment. The timbre feature is configured to represent a timbre feature of an object corresponding to a selected timbre. The prosodic duration feature is configured to represent a prosodic feature in the sample reference speech. For example, the prosodic duration feature is configured to represent a feature such as a tone, a length, and a pitch of the object corresponding to the selected timbre when the object speaks. In some examples, the prosodic duration feature is configured to represent a feature of cadence of the object corresponding to the selected timbre when the object speaks.

The sample reference speech refers to speech of the object corresponding to the selected timbre.

In some embodiments, the sample reference speech is the speech of the object corresponding to the selected timbre. In some examples, the sample reference speech is speech of the object corresponding to the selected timbre when the object reads text. In some examples, the sample reference speech is a segment of audio containing sound of the object corresponding to the selected timbre, but is not limited thereto. For example, the sample reference speech is a recording of a person A when the person A reads a piece of text.

In some embodiments, the sample reference speech may be speech with a length of 3 seconds.

The sample audio refers to audio obtained by the object corresponding to the selected timbre for the text information or the semantic information.

In some embodiments, the sample acoustic feature may be obtained by feature extraction through an acoustic encoder (which may also be referred to as an acoustic feature extraction network) in a speech synthesis model.

In some embodiments, the acoustic encoder may be implemented by a CNN, a transformer neural network, or a convolution-enhanced transformer network (Conformer). For example, the acoustic encoder may be implemented using a four-layer transformer neural network. In this disclosure, the acquisition of the acoustic feature is not limited to this implementation.

In some embodiments, the sample semantic feature may be obtained by feature extraction through a semantic encoder in the speech synthesis model.

In some embodiments, the semantic encoder may be implemented by an SSL encoder and a k-means clustering algorithm. In this disclosure, the acquisition of the semantic feature is not limited to this implementation.

In some embodiments, the computer device may concatenate the sample reference speech and the speech signal corresponding to the sample audio to obtain a concatenated speech signal. The computer device performs feature extraction on the concatenated speech signal to obtain the sample semantic feature and the sample acoustic feature.

In some embodiments, sample reference speech of a first time length and a speech signal corresponding to sample audio of a second time length are acquired. The computer device concatenates the sample reference speech and the speech signal corresponding to the sample audio to obtain the concatenated speech signal; performs feature extraction on the reference speech of the first time length through the acoustic feature extraction network to obtain the sample acoustic feature; and performs feature extraction on the speech signal corresponding to the sample audio of the second time length through a semantic feature extraction network to obtain the sample semantic feature.

For example, a 3-second sample reference speech and a 7-second speech signal corresponding to sample audio are acquired. The computer device concatenates the 3-second sample reference speech and the 7-second speech signal to obtain a 10-second concatenated speech signal; performs feature extraction on the 3-second sample reference speech through the acoustic feature extraction network to obtain the sample acoustic feature; and performs feature extraction on the 7-second speech signal through the semantic feature extraction network to obtain the sample semantic feature. The computer device finally obtains the synthesized audio based on the sample semantic feature and the sample acoustic feature, that is, the synthesized audio can be expressed using the speech of the object corresponding to the selected timbre through brief 3-second sample reference speech. For example, if a person A wants to imitate a person B to read an article, it is only necessary to acquire 3-second speech of the person B as reference speech and a speech signal of the person A reading an article. The computer device concatenates the 3-second speech of the person B and the speech signal of the person A reading an article, and then inputs the concatenated content into the speech synthesis model provided in this embodiment of this disclosure to obtain that the person A reads an article using the sound of the person B.

Operation 804: Embed the Sample Semantic Feature into the Sample Acoustic Feature Through a First-Layer Sub-Model in the Speech Synthesis Model to Obtain a Sample Intermediate Acoustic Feature.

The sample intermediate acoustic feature is configured to represent a feature obtained by embedding the sample semantic feature into the sample acoustic feature. In some examples, a sample intermediate acoustic feature is obtained by processing circuitry through a first-layer sub-model in a speech synthesis model, the first-layer sub-model being configured to output feature values of the intermediate acoustic feature based on the sample semantic feature and the sample acoustic feature.

Embedding the sample semantic feature into the sample acoustic feature refers to enabling the sample acoustic feature to learn semantic information or text information in the sample semantic feature through the first-layer sub-model, that is, to acquire text information that the sample audio wants to express.

The speech synthesis model includes a first-layer sub-model and a second-layer sub-model. The first-layer sub-model and the second-layer sub-model have the same model structure, but at least one of network parameters, execution tasks, and quantities of network layers thereof are different.

The first-layer sub-model is configured to embed the semantic feature into the acoustic feature.

In some embodiments, the first-layer sub-model may adopt at least one of an attention network Transformer, a pre-trained language representation model-BERT, and an RNN, but is not limited thereto. This is not limited in this disclosure.

Operation 806: Input the Sample Intermediate Acoustic Feature into the Second-Layer Sub-Model in the Speech Synthesis Model to Obtain an Audio Synthesis Feature.

The audio synthesis feature is configured to represent a feature corresponding to the synthesized audio. In some examples, an audio synthesis feature is obtained by the processing circuitry through a second-layer sub-model in the speech synthesis model, the second-layer sub-model being configured to output feature values of the audio synthesis feature based on the sample intermediate acoustic feature.

The second-layer sub-model is configured to synthesize the audio synthesis feature based on the sample intermediate acoustic feature.

In some embodiments, the second-layer sub-model may adopt at least one of an attention network Transformer, a BERT, or an RNN, but is not limited thereto. This is not limited in this disclosure.

### Operation 808: Generate, Based on the Audio Synthesis Feature, Synthesized Audio Having a Same Timbre as the Sample Reference Speech.

The synthesized audio is audio that imitates the sound of the object (human voice in the sample reference speech) corresponding to the selected timbre to speak to-be-expressed text information.

In some examples, the computer device decodes the audio synthesis feature to obtain the synthesized audio having the same timbre as the sample reference speech, that is, to obtain synthesized audio expressed using the human voice of the sample reference speech.

### Operation 810: Calculate a Training Loss of the Speech Synthesis Model Based on the Sample Audio and the Synthesized Audio.

In some examples, the computer device calculates the training loss of the speech synthesis model based on the sample audio and the synthesized audio.

The training loss refers to a difference between input and output of the speech synthesis model, and the performance of the speech synthesis model is measured through the training loss.

### Operation 812: Update Model Parameters of the Speech Synthesis Model According to the Training Loss.

In some examples, the computer device updates the model parameters of the speech synthesis model according to the training loss.

The updating of the model parameters refers to updating network parameters in the speech synthesis model, or updating network parameters of network modules in the model, or updating network parameters of network layers in the model, but is not limited thereto. This is not limited in this disclosure.

In summary, according to the method provided in this embodiment, the sample semantic feature, the sample acoustic feature, and the sample audio are acquired. The sample semantic feature is embedded into the sample acoustic feature through the first-layer sub-model in the speech synthesis model to obtain the sample intermediate acoustic feature. The sample intermediate acoustic feature and the sample acoustic feature are inputted into the second-layer sub-model in the speech synthesis model to obtain the audio synthesis feature. Based on the audio synthesis feature, the synthesized audio having the same timbre as the sample reference speech is generated. The training loss of the speech synthesis model is calculated based on the sample audio and the synthesized audio. The model parameters of the speech synthesis model are updated according to the training loss. In this disclosure, the semantic feature and the acoustic feature are processed, so that the finally generated audio synthesis feature can not only learn the semantic feature, but also fully learn the acoustic feature. In addition, the speech synthesis model is trained through the difference between the sample audio and the synthesized audio. Based on this, the synthesis effect of the speech synthesis model can be improved.

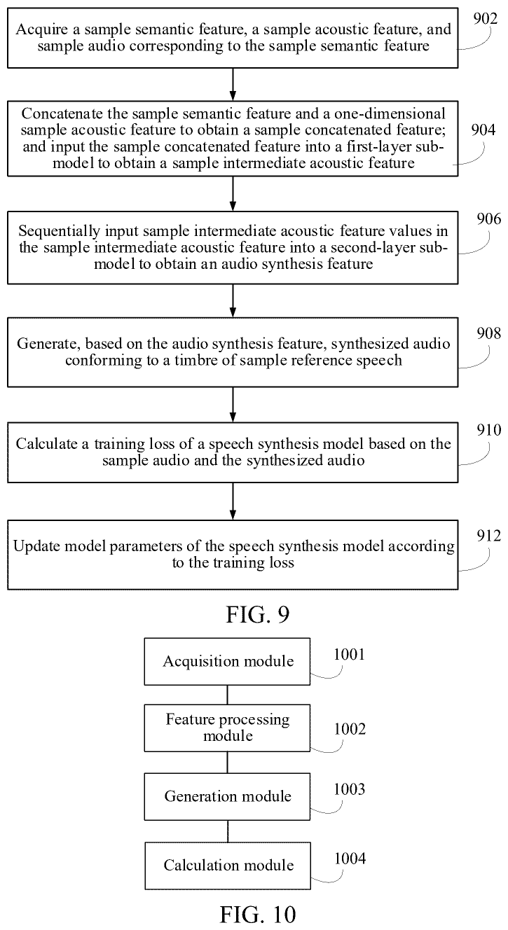

FIG. 9 is a flowchart of a method for training a speech synthesis model according to an embodiment of this disclosure. The method may be performed by a computer device. The computer device may be a terminal or a server, and is provided with a speech synthesis model. The method includes the following operations.

### Operation 902: Acquire a Sample Semantic Feature, a Sample Acoustic Feature, And Sample Audio Corresponding to the Sample Semantic Feature.

The sample semantic feature is configured to represent a feature of semantic information corresponding to the sample audio. In some examples, the sample semantic feature is configured to represent a feature of text information corresponding to the sample audio.

In some embodiments, a mode for acquiring the sample semantic feature includes: performing speech recognition on a speech signal to obtain text content; and performing feature extraction on the text content to obtain the sample semantic feature; or performing text recognition and feature extraction on text in the text content to obtain the sample semantic feature; or directly performing feature extraction on the speech signal to obtain the sample semantic feature configured to represent semantics of the speech signal.

The sample acoustic feature is a feature of acoustic information corresponding to the sample reference speech. The sample acoustic feature may represent sound production characteristics and reading characteristics of an object corresponding to a selected timbre, characteristics of a reference speech recording environment, or the like.

In some embodiments, the sample acoustic feature includes at least one of a recording environment feature, a timbre feature, and a prosodic duration feature, but is not limited thereto. This is not limited in this disclosure.

The recording environment feature is configured to represent a feature of a sample reference speech recording environment. The timbre feature is configured to represent a timbre feature of an object corresponding to a selected timbre. The prosodic duration feature is configured to represent a prosodic feature in the sample reference speech. For example, the prosodic duration feature is configured to represent a feature such as a tone, a length, and a pitch of the object corresponding to the selected timbre when the object speaks. In some examples, the prosodic duration feature is configured to represent a feature of cadence of the object corresponding to the selected timbre when the object speaks.

The sample reference speech refers to speech of the object corresponding to the selected timbre.

In some embodiments, the sample reference speech is the speech of the object corresponding to the selected timbre. In some examples, the sample reference speech is speech of the object corresponding to the selected timbre when the object reads text. In some examples, the sample reference speech is a segment of audio containing sound of the object corresponding to the selected timbre, but is not limited thereto. For example, the sample reference speech is a recording of a person A when the person A reads a piece of text.

In some embodiments, the computer device acquires the sample reference speech, and inputs the sample reference speech into an acoustic feature extraction network in the speech synthesis model for feature extraction to obtain the sample acoustic feature.

In some embodiments, the computer device inputs the sample reference speech into the acoustic feature extraction network for feature extraction to obtain an initial sample acoustic feature. The computer device quantizes the initial sample acoustic feature to obtain the sample acoustic feature.

in some examples, the initial sample acoustic feature refers to a continuous feature extracted from the sample reference speech.

Since the initial sample acoustic feature is a continuous feature, for ease of subsequent calculation, the initial sample acoustic feature needs to be quantized, to obtain the sample acoustic feature. The initial sample acoustic feature before quantization is a one-dimensional feature, and the quantized sample acoustic feature is a K-dimensional feature, K being a positive integer greater than 1. The quantized sample acoustic feature has higher expressiveness than the initial sample acoustic feature before quantization, that is, a multi-dimensional feature can more fully represent the sample acoustic feature.

For example, the initial sample acoustic feature before quantization may be represented as [a1, a2, a3], and the quantized sample acoustic feature is a three-dimensional feature, which may be represented as:

$$[ \begin{matrix}a 11 & a 21 & a 31 \\ a 12 & a 22 & a 32 \\ a 13 & a 23 & a 33\end{matrix} ] .$$

The operation of quantizing the initial sample acoustic feature to the sample acoustic feature includes: quantizing, by the computer device, an m^{th} acoustic feature value in the initial sample acoustic feature to obtain a first quantized acoustic feature value in an m^{th} column in the sample acoustic feature, m being a positive integer; quantizing, by the computer device, a residual between the first quantized acoustic feature value and the m^{th} acoustic feature value to obtain a second quantized acoustic feature value in the m^{th} column; quantizing, by the computer device, a residual between a kth quantized acoustic feature value and a (k−1)^{th} quantized acoustic feature value to obtain a (k+1)^{th} quantized acoustic feature value in the m^{th} column, k being a positive integer greater than 1; combining, by the computer device, the previous (k+1) quantized acoustic feature values in the m^{th} column to obtain a quantized acoustic feature value of the m^{th} column in the sample acoustic feature; and repeating the foregoing operations, and combining quantized acoustic feature values of columns to obtain the sample acoustic feature.

For example, the computer device quantizes a first acoustic feature value a1 in the initial sample acoustic feature to obtain a first quantized acoustic feature value a11 in a first column in the sample acoustic feature; quantizes a residual between the first acoustic feature value a1 and the first quantized acoustic feature value a11 in the first column to obtain a second quantized acoustic feature value a12 in the first column; quantizes a residual between the second quantized acoustic feature value a12 and the first quantized acoustic feature value a11 in the first column to obtain a third quantized acoustic feature value a13 in the first column; combines quantized acoustic feature values in the first column to obtain an acoustic feature of the first column in the sample acoustic feature; performs the foregoing operations on the other columns to obtain acoustic features of the other columns in the sample acoustic feature; and combines quantized acoustic feature values of the columns to obtain the sample acoustic feature.

In some embodiments, the dimension of the sample acoustic feature may be manually set as required.

In some embodiments, a mode for acquiring the sample reference speech includes at least one of the following cases.
1. The computer device receives the sample reference speech. For example, the terminal is a terminal initiating audio recording. Audio is recorded through the terminal and used as the sample reference speech after the recording ends.
2. The computer device acquires the sample reference speech from a stored database.

The foregoing examples for acquiring the sample reference speech are merely non-limiting examples. This is not limited in this disclosure.

Operation 904: Concatenate the Sample Semantic Feature and a One-Dimensional Sample Acoustic Feature to Obtain a Sample Concatenated Feature; and Input the Sample Concatenated Feature into a First-Layer Sub-Model to Obtain a Sample Intermediate Acoustic Feature.

The sample concatenated feature refers to a feature obtained by concatenating the sample semantic feature and the one-dimensional sample acoustic feature. In some examples, a one-dimensional sample acoustic feature is obtained based on the sample acoustic feature, each feature value of the one-dimensional sample acoustic feature being based on a summation of feature values in each column of the sample acoustic feature. In some examples, the sample semantic feature and the one-dimensional sample acoustic feature are concatenated to obtain a sample concatenated feature as input of the first-layer sub-model.

The sample acoustic feature is a feature of acoustic information corresponding to the sample reference speech. The sample acoustic feature is a K-dimensional feature, K being a positive integer greater than 1.

In some examples, the computer device adds feature values in the same column in the sample acoustic feature to obtain the one-dimensional sample acoustic feature.

For example, the sample acoustic feature is a three-dimensional feature, which may be represented as:

$$[ \begin{matrix}a 11 & a 21 & a 31 \\ a 12 & a 22 & a 32 \\ a 13 & a 23 & a 33\end{matrix} ] .$$

The computer device adds feature values in a first column in the sample acoustic feature. For example, values of a11, a12, and a13 are added to obtain a first acoustic feature value A1 in the one-dimensional sample acoustic feature. Similarly, values of a21, a22, and a23 are added to obtain a second acoustic feature value A2 in the one-dimensional sample acoustic feature. Values of a31, a32, and a33 are added to obtain a third acoustic feature value A3 in the one-dimensional sample acoustic feature. Therefore, the obtained one-dimensional sample acoustic feature may be represented as [A1, A2, A3].

In some examples, the obtaining the audio synthesis feature through the second-layer sub-model includes obtaining a first sample intermediate acoustic feature value of the sample intermediate acoustic feature through inputting the sample concatenated feature to the first-layer sub-model; and obtaining an i-th sample intermediate acoustic feature value of the sample intermediate acoustic feature through inputting an (i−1)-th audio synthesis feature value of the audio synthesis feature and the sample concatenated feature to the first-layer sub-model, the (i−1)-th audio synthesis feature value being obtained through inputting the (i−1)-th sample intermediate acoustic feature value of the sample intermediate acoustic feature into the second-layer sub-model. In these examples, the sample intermediate acoustic feature includes N sample intermediate acoustic feature values, N is a positive integer greater than two, and i is a positive integer ranging from 2 to N.

In some embodiments, the sample semantic feature may be represented as [s1, s2, s3]. The computer device concatenates the sample semantic feature and the one-dimensional sample acoustic feature to obtain the sample concatenated feature, and the obtained sample concatenated feature may be represented as [Bos, s1, s2, s3, Bos, A1, A2, A3], where Bos is configured to represent a beginning-of-sequence token. The computer device inputs the sample concatenated feature into the first-layer sub-model to obtain a first sample intermediate acoustic feature value in the sample intermediate acoustic feature through prediction; inputs an (i−1)^{th} audio synthesis feature value corresponding to an (i−1)^{th} sample intermediate acoustic feature value and the concatenated feature into the first-layer sub-model to predict a sample intermediate acoustic feature value, to obtain an i^{th} sample intermediate acoustic feature value, the (i−1)^{th} audio synthesis feature value being obtained through prediction by inputting the (i−1)^{th} sample intermediate acoustic feature value into the second-layer sub-model; repeats the previous operation until a quantity of outputted sample intermediate acoustic feature values is equal to a quantity N of feature values in the one-dimensional sample acoustic feature, i being a positive integer greater than 1 and less than N; and combines N sample intermediate acoustic feature values to obtain the sample intermediate acoustic feature, i being a positive integer greater than 1.

In some examples, the computer device adds feature values in the same column in the sample acoustic feature to obtain the one-dimensional sample acoustic feature. The sample semantic feature may be represented as [s1, s2, s3]. The computer device concatenates the sample semantic feature and the one-dimensional sample acoustic feature to obtain a sample concatenated feature, and the obtained sample concatenated feature may be represented as [Bos, s1, s2, s3, Bos, A1, A2, A3], where Bos is configured to represent a beginning-of-sequence token. The computer device inputs the sample concatenated feature into the first-layer sub-model to obtain a first sample intermediate acoustic feature value in the sample intermediate acoustic feature. The computer device inputs a first audio synthesis feature value corresponding to the generated first sample intermediate acoustic feature value and the sample concatenated feature into the first-layer sub-model to predict a sample intermediate acoustic feature value, to obtain a second sample intermediate acoustic feature value. The first audio synthesis feature value is obtained through prediction by inputting the first sample intermediate acoustic feature value into the second-layer sub-model. The computer device inputs a second audio synthesis feature value corresponding to the generated second sample intermediate acoustic feature value and the sample concatenated feature into the first-layer sub-model to predict a sample intermediate acoustic feature value, to obtain a third sample intermediate acoustic feature value. The second audio synthesis feature value is obtained through prediction by inputting the second intermediate acoustic feature value into the second-layer sub-model. The rest may be deduced by analogy until a quantity of sample intermediate acoustic feature values outputted by the first-layer sub-model is equal to a quantity of feature values in the one-dimensional sample acoustic feature. For example, the one-dimensional sample acoustic feature may be represented as [Bos, A1, A2, A3], including three feature values. When the first-layer sub-model outputs three sample intermediate acoustic feature values, the first-layer sub-model ends prediction. The computer device combines the generated sample intermediate acoustic feature values to obtain the sample intermediate acoustic feature, which may be represented as [h1, h2, h3, Eos].

The speech synthesis model includes a first-layer sub-model and a second-layer sub-model. The first-layer sub-model and the second-layer sub-model have the same model structure, but at least one of network parameters, execution tasks, and quantities of network layers thereof are different.

The first-layer sub-model is configured to embed the sample semantic feature into the sample acoustic feature.

In some embodiments, the first-layer sub-model may adopt at least one of an attention network Transformer, a pre-trained language representation model-BERT, and an RNN, but is not limited thereto. This is not limited in this disclosure.

Operation 906: Sequentially Input Sample Intermediate Acoustic Feature Values in the Sample Intermediate Acoustic Feature into the Second-Layer Sub-Model to Obtain an Audio Synthesis Feature.

The audio synthesis feature is configured to represent a feature corresponding to the synthesized audio. In some examples, sample intermediate acoustic feature values of the sample intermediate acoustic feature are sequentially inputted into the second-layer sub-model to obtain respective audio synthesis feature values of the audio synthesis feature.

The second-layer sub-model is configured to synthesize the audio synthesis feature based on the sample intermediate acoustic feature.

In some embodiments, the second-layer sub-model may adopt at least one of an attention network Transformer, a BERT, or an RNN, but is not limited thereto. This is not limited in this disclosure.

In some examples, the computer device sequentially inputs the sample intermediate acoustic feature values in the sample intermediate acoustic feature into the second-layer sub-model to obtain the audio synthesis feature.

In some examples, the method includes providing a (j−1)-th audio synthesis feature value of the audio synthesis feature value to the first-layer sub-model that is configured to output a j-th sample intermediate acoustic feature value of the sample intermediate acoustic feature based on the sample semantic feature, the sample acoustic feature, and the (j−1)-th audio synthesis feature value. In these examples, the sample intermediate acoustic feature includes N sample intermediate acoustic feature values, N is a positive integer greater than two, and j is a positive integer ranging from 2 to N.

In some examples, the computer device inputs a first sample intermediate acoustic feature value in the sample intermediate acoustic feature into the second-layer sub-model to obtain a first audio synthesis feature value in the audio synthesis feature through prediction, the audio synthesis feature value referring to a feature value in the audio synthesis feature; inputs a j^{th} sample intermediate acoustic feature value generated by a (j−1)^{th} audio synthesis feature value into the second-layer sub-model to predict an audio synthesis feature value, to obtain a j^{th} audio synthesis feature value, the j^{th} sample intermediate acoustic feature value being obtained through prediction by inputting the (j−1)^{th} audio synthesis feature value into the first-layer sub-model; repeats a previous operation until a quantity of outputted audio synthesis feature values is equal to a quantity N of sample intermediate acoustic feature values in the sample intermediate acoustic feature, j being a positive integer greater than 1 and less than N; and combines N audio synthesis feature values to obtain the audio synthesis feature, j being a positive integer greater than 1.

In some examples, the computer device inputs a first sample intermediate acoustic feature value in the sample intermediate acoustic feature into the second-layer sub-model to predict an audio synthesis feature value in the audio synthesis feature, to obtain a first audio synthesis feature value in the audio synthesis feature; inputs the generated first audio synthesis feature value and the sample concatenated feature into the first-layer sub-model to obtain a second sample intermediate acoustic feature value; inputs the generated second sample intermediate acoustic feature value into the second-layer sub-model to predict an audio synthesis feature value, to obtain a second audio synthesis feature value; inputs the generated first audio synthesis feature value, the generated second audio synthesis feature value, and the sample concatenated feature into the first-layer sub-model to obtain a third sample intermediate acoustic feature value; and inputs the generated third sample intermediate acoustic feature value into the second-layer sub-model to predict an audio synthesis feature value, to obtain a third audio synthesis feature value. The rest may be deduced by analogy until a quantity of outputted audio synthesis feature values is equal to a quantity of sample intermediate acoustic feature values in the sample intermediate acoustic feature or until no sample intermediate acoustic feature value is inputted into the second-layer sub-model. The computer device combines the generated audio synthesis feature values to obtain the audio synthesis feature.

### Operation 908: Generate, Based on the Audio Synthesis Feature, Synthesized Audio Conforming to the Timbre of the Sample Reference Speech.

The synthesized audio is audio that imitates the sound of the object (human voice in the reference speech) corresponding to the selected timbre to speak to-be-expressed text information.

In some examples, the computer device decodes the audio synthesis feature to obtain the synthesized audio having the same timbre as the sample reference speech, that is, to obtain synthesized audio expressed using the human voice of the sample reference speech.

In some embodiments, the audio synthesis feature may be obtained by feature decoding through a decoder in a speech synthesis model.

In some embodiments, the decoder may be implemented by a CNN, a transformer neural network, or a convolution-enhanced transformer network (Conformer). For example, the decoder may be implemented using a six-layer transformer neural network. In this disclosure, a structure of the decoder is not limited to this implementation.

### Operation 910: Calculate a Training Loss of the Speech Synthesis Model Based on the Sample Audio and the Synthesized Audio.

In some examples, the computer device calculates the training loss of the speech synthesis model based on the sample audio and the synthesized audio.

The training loss refers to a difference between input and output of the speech synthesis model, and the performance of the speech synthesis model is measured through the training loss.

### Operation 912: Update Model Parameters of the Speech Synthesis Model According to the Training Loss.

In some examples, the computer device updates the model parameters of the speech synthesis model according to the training loss.

The updating of the model parameters refers to updating network parameters in the speech synthesis model, or updating network parameters of network modules in the model, or updating network parameters of network layers in the model, but is not limited thereto. This is not limited in this disclosure.

Based on a loss function value, the loss function value is used as a training indicator to update the model parameters of the first-layer sub-model and the second-layer sub-model in the speech synthesis model until the loss function value converges, thereby obtaining a trained speech synthesis model.

“The loss function value converges” refers to at least one of the following cases: the loss function value no longer changing, an error difference between two adjacent iterations during training of the speech synthesis model being less than a preset value, or a quantity of times of training of the speech synthesis model reaching a preset quantity of times, but is not limited thereto. This is not limited in this disclosure.

In some embodiments, a target condition satisfied by the training may be that a quantity of times of iterations of training of an initial model reaches a target quantity of times. A technician may preset the quantity of times of iterations of training. In some examples, the target condition satisfied by the training may be that a loss value satisfies a target threshold condition, for example, the loss value is less than 0.00001, but is not limited thereto. This is not limited in this disclosure.

In summary, according to the method provided in this embodiment, the sample semantic feature, the sample acoustic feature, and the sample audio are acquired. The sample semantic feature is embedded into the sample acoustic feature through the first-layer sub-model in the speech synthesis model to obtain the sample intermediate acoustic feature. The sample intermediate acoustic feature is inputted into the second-layer sub-model in the speech synthesis model to obtain the audio synthesis feature. Based on the audio synthesis feature, the synthesized audio having the same timbre as the sample reference speech is generated. The training loss of the speech synthesis model is calculated based on the sample audio and the synthesized audio. The model parameters of the speech synthesis model are updated according to the training loss. In this disclosure, the semantic feature and the acoustic feature are processed, so that the finally generated audio synthesis feature can not only learn the semantic feature, but also fully learn the acoustic feature. In addition, the speech synthesis model is trained through the difference between the sample audio and the synthesized audio. Based on this, the synthesis effect of the speech synthesis model can be improved.

FIG. 10 is a schematic structural diagram of a speech synthesis apparatus according to an embodiment of this disclosure. The apparatus may be implemented as all or a part of a computer device through software, hardware, or a combination thereof. The apparatus includes:
an acquisition module 1001, configured to acquire a semantic feature and an acoustic feature, the semantic feature being configured to represent a feature of text information corresponding to target audio, the acoustic feature being a feature of acoustic information corresponding to reference speech, and the reference speech referring to speech of an object corresponding to a selected timbre;
a feature processing module 1002, configured to embed the semantic feature into the acoustic feature through a first-layer sub-model in a speech synthesis model to obtain an intermediate acoustic feature, the first-layer sub-model being configured to embed the semantic feature into the acoustic feature, and the intermediate acoustic feature being configured to represent a feature obtained by embedding the semantic feature into the acoustic feature; and
the feature processing module 1002 being further configured to input the intermediate acoustic feature into a second-layer sub-model in the speech synthesis model to obtain an audio synthesis feature, the second-layer sub-model being configured to synthesize the audio synthesis feature based on the intermediate acoustic feature, and the audio synthesis feature being configured to represent a feature corresponding to the target audio; and
a generation module 1003, configured to generate, based on the audio synthesis feature, synthesized audio having a same timbre as the reference speech.

In some embodiments, the feature processing module 1002 is further configured to add feature values in a same column in the acoustic feature to obtain a one-dimensional acoustic feature; concatenate the semantic feature and the one-dimensional acoustic feature to obtain a concatenated feature, the concatenated feature referring to a feature obtained by concatenating the semantic feature and the one-dimensional acoustic feature; and input the concatenated feature into the first-layer sub-model to obtain the intermediate acoustic feature.

In some embodiments, the feature processing module 1002 is further configured to input the concatenated feature into the first-layer sub-model to predict an intermediate acoustic feature value in the intermediate acoustic feature, to obtain a first intermediate acoustic feature value in the intermediate acoustic feature, the intermediate acoustic feature referring to a feature obtained through prediction by the first-layer sub-model based on the concatenated feature, and the intermediate acoustic feature value referring to a feature value in the intermediate acoustic feature; input an (i−1)^{th} audio synthesis feature value corresponding to an (i−1)^{th} intermediate acoustic feature value and the concatenated feature into the first-layer sub-model to predict the intermediate acoustic feature value, to obtain an i^{th} intermediate acoustic feature value, the (i−1)^{th} audio synthesis feature value being obtained through prediction by inputting the (i−1)^{th} intermediate acoustic feature value into the second-layer sub-model; repeat a previous operation until a quantity of outputted intermediate acoustic feature values is equal to a quantity of feature values in the one-dimensional acoustic feature; and combine the i^{th} intermediate acoustic feature value and previous (i−1) intermediate acoustic feature values to obtain the intermediate acoustic feature, i being a positive integer greater than 1.

In some embodiments, the feature processing module 1002 is further configured to sequentially input intermediate acoustic feature values in the intermediate acoustic feature into the second-layer sub-model to obtain the audio synthesis feature.

In some embodiments, the feature processing module 1002 is further configured to input a first intermediate acoustic feature value in the intermediate acoustic feature into the second-layer sub-model to obtain a first audio synthesis feature value in the audio synthesis feature through prediction, the audio synthesis feature value referring to a feature value in the audio synthesis feature; input a j^{th} intermediate acoustic feature value generated by a (j−1)^{th} audio synthesis feature value into the second-layer sub-model to predict an audio synthesis feature value, to obtain a j^{th} audio synthesis feature value, the j^{th} intermediate acoustic feature value being obtained through prediction by inputting the (j−1)^{th} audio synthesis feature value into the first-layer sub-model; repeat a previous operation until a quantity of outputted audio synthesis feature values is equal to a quantity N of intermediate acoustic feature values in the intermediate acoustic feature, j being a positive integer greater than 1 and less than N; and combine N audio synthesis feature values to obtain the audio synthesis feature.

In some embodiments, the acquisition module 1001 is further configured to acquire the reference speech; and perform feature extraction on the reference speech to obtain the acoustic feature.

In some embodiments, the apparatus further includes a calculation module 1004. The calculation module 1004 is further configured to input the reference speech into an acoustic feature extraction network for feature extraction to obtain an initial acoustic feature, the initial acoustic feature referring to a continuous feature extracted from the reference speech; and quantize the initial acoustic feature to obtain the acoustic feature.

In some embodiments, the calculation module 1004 is further configured to quantize an m^{th} acoustic feature value in the initial acoustic feature to obtain a first quantized acoustic feature value in an m^{th} column in the acoustic feature, m being a positive integer; quantize a residual between the first quantized acoustic feature value and the m^{th} acoustic feature value to obtain a second quantized acoustic feature value in the m^{th} column; quantize a residual between a kth quantized acoustic feature value and a (k−1)^{th} quantized acoustic feature value to obtain a (k+1)^{th} quantized acoustic feature value in the m^{th} column, k being a positive integer greater than 1; combine all quantized acoustic feature values in the m^{th} column to obtain a quantized acoustic feature value of the m^{th} column in the acoustic feature; and repeat the foregoing operations, and combine quantized acoustic feature values of columns to obtain the acoustic feature.

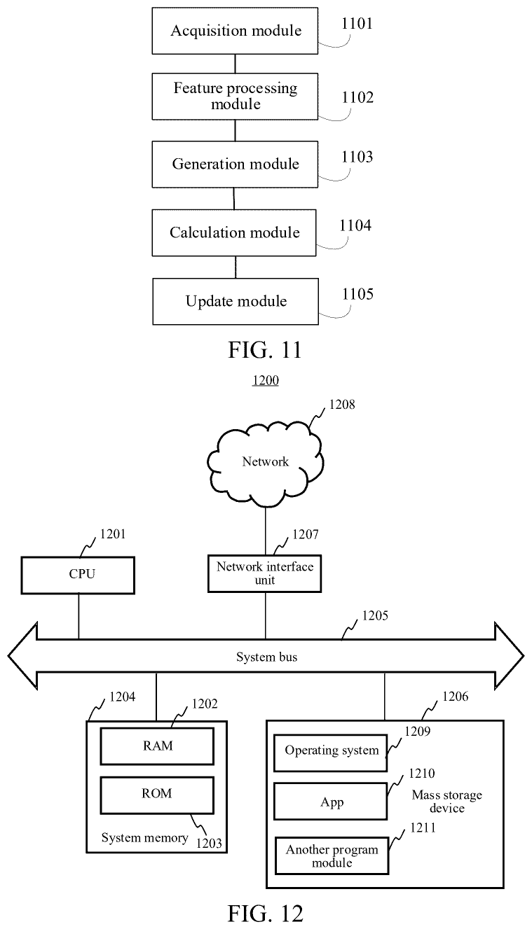

FIG. 11 is a schematic structural diagram of an apparatus for training a speech synthesis model according to an embodiment of this disclosure. The apparatus may be implemented as all or a part of a computer device through software, hardware, or a combination thereof. The apparatus includes:
an acquisition module 1101, configured to acquire a sample semantic feature, a sample acoustic feature, and sample audio, the sample semantic feature being configured to represent a feature of text information corresponding to target audio, the sample acoustic feature being a feature of acoustic information corresponding to sample reference speech, and the sample reference speech referring to speech of an object corresponding to a selected timbre;
a feature processing module 1102, configured to embed the sample semantic feature into the sample acoustic feature through a first-layer sub-model in the speech synthesis model to obtain a sample intermediate acoustic feature, the first-layer sub-model being configured to embed the sample semantic feature into the sample acoustic feature, and the sample intermediate acoustic feature being configured to represent a feature obtained by embedding the sample semantic feature into the sample acoustic feature; and
the feature processing module 1102 being further configured to input the sample intermediate acoustic feature into a second-layer sub-model in the speech synthesis model to obtain an audio synthesis feature, the second-layer sub-model being configured to synthesize the audio synthesis feature based on the sample intermediate acoustic feature, and the audio synthesis feature being configured to represent a feature corresponding to the target audio;
a generation module 1103, configured to generate, based on the audio synthesis feature, synthesized audio having a same timbre as the sample reference speech;
a calculation module 1104, configured to calculate a training loss of the speech synthesis model based on the sample audio and the synthesized audio; and
an update module 1105, configured to update model parameters of the speech synthesis model according to the training loss.

In some embodiments, the feature processing module 1102 is further configured to add feature values in a same column in the sample acoustic feature to obtain a one-dimensional sample acoustic feature; concatenate the sample semantic feature and the one-dimensional sample acoustic feature to obtain a sample concatenated feature, the sample concatenated feature referring to a feature obtained by concatenating the sample semantic feature and the one-dimensional sample acoustic feature; and input the sample concatenated feature into the first-layer sub-model to obtain the sample intermediate acoustic feature.

In some embodiments, the feature processing module 1102 is further configured to input the sample concatenated feature into the first-layer sub-model to obtain a first sample intermediate acoustic feature value in the sample intermediate acoustic feature through prediction, the intermediate acoustic feature referring to a feature obtained through prediction by the first-layer sub-model based on the concatenated feature, and the sample intermediate acoustic feature value referring to a feature value in the sample intermediate acoustic feature; input an (i−1)^{th} audio synthesis feature value corresponding to an (i−1)^{th} sample intermediate acoustic feature value and the sample concatenated feature into the first-layer sub-model to predict the sample intermediate acoustic feature value, to obtain an i^{th} sample intermediate acoustic feature value, the (i−1)^{th} audio synthesis feature value being obtained through prediction by inputting the (i−1)^{th} sample intermediate acoustic feature value into the second-layer sub-model; repeat a previous operation until a quantity of outputted sample intermediate acoustic feature values is equal to a quantity N of feature values in the one-dimensional sample acoustic feature, i being a positive integer greater than 1 and less than N; and combine N sample intermediate acoustic feature values to obtain the sample intermediate acoustic feature, i being a positive integer greater than 1.

In some embodiments, the feature processing module 1102 is further configured to sequentially input sample intermediate acoustic feature values in the sample intermediate acoustic feature into the second-layer sub-model to obtain the audio synthesis feature.

In some embodiments, the feature processing module 1102 is further configured to input a first sample intermediate acoustic feature value in the sample intermediate acoustic feature into the second-layer sub-model to obtain a first audio synthesis feature value in the audio synthesis feature through prediction; input a j^{th} sample intermediate acoustic feature value generated by a (j−1)^{th} audio synthesis feature value into the second-layer sub-model to predict an audio synthesis feature value, to obtain a j^{th} audio synthesis feature value in the audio synthesis feature, the j^{th} sample intermediate acoustic feature value being obtained through prediction by inputting the (j−1)^{th} audio synthesis feature value into the first-layer sub-model; repeat a previous operation until a quantity of outputted audio synthesis feature values is equal to a quantity N of sample intermediate acoustic feature values in the sample intermediate acoustic feature, j being a positive integer greater than 1 and less than N; and combine N audio synthesis feature values to obtain the audio synthesis feature, j being a positive integer greater than 1.

In some embodiments, the acquisition module 1101 is further configured to acquire the sample reference speech; and input the sample reference speech into an acoustic feature extraction network in the speech synthesis model for feature extraction to obtain the sample acoustic feature.

In some embodiments, the calculation module 1104 is further configured to input the sample reference speech into an acoustic feature extraction network for feature extraction to obtain an initial sample acoustic feature, the initial sample acoustic feature referring to a continuous feature extracted from the sample reference speech; and quantize the initial sample acoustic feature to obtain the sample acoustic feature.

In some embodiments, the calculation module 1104 is further configured to quantize an m^{th} acoustic feature value in the initial sample acoustic feature to obtain a first quantized acoustic feature value in an m^{th} column in the sample acoustic feature, m being a positive integer; quantize a residual between the first sample quantized acoustic feature value and the m^{th} sample acoustic feature value to obtain a second sample quantized acoustic feature value in the m^{th} column; quantize a residual between a kth quantized acoustic feature value and a (k−1)^{th} quantized acoustic feature value to obtain a (k+1)^{th} quantized acoustic feature value in the m^{th} column, k being a positive integer greater than 1; combine all quantized acoustic feature values in the m^{th} column to obtain a quantized acoustic feature value of the m^{th} column in the sample acoustic feature; and repeat the foregoing operations, and combine quantized acoustic feature values of columns to obtain the sample acoustic feature.

FIG. 12 is a structural block diagram of a computer device 1200 according to an embodiment of this disclosure. The computer device may be implemented as the server in the foregoing solution in this disclosure. The computer device 1200 includes processing circuitry (e.g., a central processing unit (CPU) 1201), a system memory 1204 including a random access memory (RAM) 1202 and a read-only memory (ROM) 1203, and a system bus 1205 connecting the system memory 1204 and the CPU 1201. The computer device 1200 further includes a mass storage device 1206 configured to store an operating system 1209, an APP 1210, and another program module 1211.

The mass storage device 1206 is connected to the CPU 1201 through a mass storage controller (not shown) connected to the system bus 1205. The mass storage device 1206 and a computer-readable medium associated therewith provide non-volatile storage for the computer device 1200. In other words, the mass storage device 1206 may include a non-transitory computer-readable medium (not shown) such as a hard disk or a compact disc read-only memory (CD-ROM) drive.

The computer storage medium may include volatile and non-volatile media (and hence may include a non-transitory computer-readable storage medium), and removable and non-removable media implemented using any method or technology used for storing information such as computer-readable instructions, data structures, program modules, or other data. The computer storage medium includes a RAM, an erasable programmable ROM (EPROM), an electrically-erasable programmable ROM (EEPROM), a flash memory or another solid-state memory technology, a CD-ROM, a digital versatile disc (DVD) or another optical memory, a magnetic cassette, a magnetic tape, a magnetic disk memory, or another magnetic storage device. In this disclosure, a person skilled in the art may learn that the computer storage medium is not limited to the foregoing several types. The system memory 1204 and the mass storage device 1206 may be collectively referred to as a memory.

According to the embodiments of the present disclosure, the computer device 1200 may be further connected, through a network such as the Internet, to a remote computer on the network and run. That is, the computer device 1200 may be connected to a network 1208 through a network interface unit 1207 connected to the system bus 1205, or may be connected to another type of network or a remote computer system (not shown) using the network interface unit 1207.

The memory further includes at least one computer program. The at least one computer program is stored in the memory. The CPU 1201 executes the at least one computer program to implement all or some operations of the speech synthesis method or the method for training a speech synthesis model provided in the foregoing embodiments.

The embodiments of this disclosure further provide a computer device, including processing circuitry (e.g., a processor) and a memory (e.g., including a non-transitory computer-readable storage medium). The memory has at least one program stored therein, and the at least one program is loaded and executed by the processor to implement the speech synthesis method or the method for training a speech synthesis model provided in the foregoing method embodiments.

The embodiments of this disclosure further provide a non-transitory computer-readable storage medium. The non-transitory computer-readable storage medium has at least one computer program stored therein, and the at least one computer program is loaded and executed by processing circuitry (e.g., a processor) to implement the speech synthesis method or the method for training a speech synthesis model provided in the foregoing method embodiments.

The embodiments of this disclosure further provide a computer program product, including a computer program. The computer program is stored in a non-transitory computer-readable storage medium. Processing circuitry (e.g., a processor) of a computer device reads the computer program from the non-transitory computer-readable storage medium and executes the computer program to cause the computer device to perform the speech synthesis method or the method for training a speech synthesis model provided in the foregoing method embodiments.

Unless otherwise explicitly defined herein, all terms used in the claims are explained according to their ordinary meanings in the technical field. Unless otherwise explicitly stated, all reference to “an element, an apparatus, a component, a device, an operation, or the like” is to be openly interpreted as referring to at least one instance of the element, the apparatus, the component, the device, the operation, or the like. Unless explicitly stated, operations of any method disclosed herein do not need to be performed in the exact sequence disclosed.

“A plurality of” mentioned herein refers to two or more. “And/or” describes an association relationship of associated objects and represents that three relationships may exist. For example, A and/or B may represent the following three cases: only A exists, both A and B exist, and only B exists. The character “/” may represent an “or” relationship between the associated objects.

A person skilled in the art may understand that all or some of the operations of the foregoing embodiments may be implemented by hardware, or may be implemented by a program instructing relevant hardware. The program may be stored in a non-transitory computer-readable storage medium. The foregoing storage medium may be a ROM, a magnetic disk, an optical disc, or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely non-limiting embodiments of this disclosure, and are not intended to limit this disclosure. Any modification, equivalent replacement, or improvement made within the spirit and principle of this disclosure shall fall within the scope of this disclosure.

What is claimed is:

1. A speech synthesis method, comprising:
acquiring a semantic feature of text information that corresponds to content of to-be-synthesized target audio;
acquiring an acoustic feature of reference speech that corresponds to a target timbre of the to-be-synthesized target audio;
obtaining, by processing circuitry, an intermediate acoustic feature through a first-layer sub-model in a speech synthesis model, the first-layer sub-model being configured to output feature values of the intermediate acoustic feature based on the semantic feature and the acoustic feature;
obtaining, by the processing circuitry, an audio synthesis feature through a second-layer sub-model in the speech synthesis model, the second-layer sub-model being configured to output feature values of the audio synthesis feature based on the intermediate acoustic feature; and
generating, based on the audio synthesis feature, target audio conforming to the target timbre of the reference speech.

2. The method according to claim 1, wherein the obtaining the intermediate acoustic feature comprises:
obtaining a one-dimensional acoustic feature based on the acoustic feature, each feature value of the one-dimensional acoustic feature being based on a summation of feature values in each column of the acoustic feature; and
concatenating the semantic feature and the one-dimensional acoustic feature to obtain a concatenated feature as input of the first-layer sub-model.

3. The method according to claim 2, wherein the obtaining the audio synthesis feature comprises:
obtaining a first intermediate acoustic feature value of the intermediate acoustic feature through inputting the concatenated feature to the first-layer sub-model; and
obtaining an i-th intermediate acoustic feature value of the intermediate acoustic feature through inputting an (i−1)-th audio synthesis feature value of the audio synthesis feature and the concatenated feature to the first-layer sub-model, the (i−1)-th audio synthesis feature value being obtained through inputting the (i−1)-th intermediate acoustic feature value of the intermediate acoustic feature into the second-layer sub-model, wherein
the intermediate acoustic feature includes N intermediate acoustic feature values,
N is a positive integer greater than two, and
i is a positive integer ranging from 2 to N.

4. The method according to claim 1, wherein the obtaining the audio synthesis feature comprises:
sequentially inputting intermediate acoustic feature values of the intermediate acoustic feature into the second-layer sub-model to obtain respective audio synthesis feature values of the audio synthesis feature.

5. The method according to claim 4, further comprising:
providing a (j−1)-th audio synthesis feature value of the audio synthesis feature value to the first-layer sub-model that is configured to output a j-th intermediate acoustic feature value of the intermediate acoustic feature based on the semantic feature, the acoustic feature, and the (j−1)-th audio synthesis feature value, wherein
the intermediate acoustic feature includes N intermediate acoustic feature values,
N is a positive integer greater than two, and
j is a positive integer ranging from 2 to N.

6. The method according to claim 1, further comprising:
acquiring the reference speech; and
performing feature extraction on the reference speech to obtain the acoustic feature.

7. The method according to claim 6, wherein the performing the feature extraction on the reference speech comprises:
inputting the reference speech into an acoustic feature extraction network to obtain an initial acoustic feature; and
quantizing the initial acoustic feature to obtain the acoustic feature.

8. The method according to claim 7, wherein
the initial acoustic feature is a one-dimensional feature that includes M initial feature values, M being a positive integer greater than two,
the acoustic feature is a multi-dimensional feature arranged in a matrix form that includes M column and K rows of acoustic feature values, K being a positive integer greater than two, and
the quantizing the initial acoustic feature includes:
quantizing an m-th initial feature value of the initial acoustic feature to obtain a first quantized acoustic feature value in an m-th column and a first row in the acoustic feature, m being a positive integer ranging from 1 to M;
quantizing a first residual between the first quantized acoustic feature value and the m-th initial feature value to obtain a second quantized acoustic feature value in the m-th column and a second row in the acoustic feature; and
quantizing a k-th residual between a k-th quantized acoustic feature value and a (k−1)-th quantized acoustic feature value to obtain a (k+1)-th quantized acoustic feature value in the m-th column and (k+1)-th row in the acoustic feature, k being a positive integer ranging from 2 to (K−1).

9. A method for training a speech synthesis model, the method comprising:
acquiring sample audio that corresponds to a reference timbre;
acquiring a sample semantic feature of the sample audio;
acquiring a sample acoustic feature of sample reference speech that corresponds to the reference timbre;
obtaining, by processing circuitry, a sample intermediate acoustic feature through a first-layer sub-model in a speech synthesis model, the first-layer sub-model being configured to output feature values of the intermediate acoustic feature based on the sample semantic feature and the sample acoustic feature;
obtaining, by the processing circuitry, an audio synthesis feature through a second-layer sub-model in the speech synthesis model, the second-layer sub-model being configured to output feature values of the audio synthesis feature based on the sample intermediate acoustic feature;
generating synthesized audio based on the audio synthesis feature;
calculating a training loss of the speech synthesis model based on the sample audio and the synthesized audio; and
updating model parameters of the speech synthesis model according to the training loss.

10. The method according to claim 9, wherein the obtaining the sample intermediate acoustic feature comprises:
obtaining a one-dimensional sample acoustic feature based on the sample acoustic feature, each feature value of the one-dimensional sample acoustic feature being based on a summation of feature values in each column of the sample acoustic feature; and
concatenating the sample semantic feature and the one-dimensional sample acoustic feature to obtain a sample concatenated feature as input of the first-layer sub-model.

11. The method according to claim 10, wherein the obtaining the audio synthesis feature comprises:
obtaining a first sample intermediate acoustic feature value of the sample intermediate acoustic feature through inputting the sample concatenated feature to the first-layer sub-model; and
obtaining an i-th sample intermediate acoustic feature value of the sample intermediate acoustic feature through inputting an (i−1)-th audio synthesis feature value of the audio synthesis feature and the sample concatenated feature to the first-layer sub-model, the (i−1)-th audio synthesis feature value being obtained through inputting the (i−1)-th sample intermediate acoustic feature value of the sample intermediate acoustic feature into the second-layer sub-model, wherein
the sample intermediate acoustic feature includes N sample intermediate acoustic feature values,
N is a positive integer greater than two, and
i is a positive integer ranging from 2 to N.

12. The method according to claim 9, wherein the obtaining the audio synthesis feature comprises:
sequentially inputting sample intermediate acoustic feature values of the sample intermediate acoustic feature into the second-layer sub-model to obtain respective audio synthesis feature values of the audio synthesis feature.

13. The method according to claim 12, further comprising:
providing a (j−1)-th audio synthesis feature value of the audio synthesis feature value to the first-layer sub-model that is configured to output a j-th sample intermediate acoustic feature value of the sample intermediate acoustic feature based on the sample semantic feature, the sample acoustic feature, and the (j−1)-th audio synthesis feature value, wherein
the sample intermediate acoustic feature includes N sample intermediate acoustic feature values,
N is a positive integer greater than two, and
j is a positive integer ranging from 2 to N.

14. The method according to claim 9, further comprising:
acquiring the sample reference speech; and
performing feature extraction on the sample reference speech to obtain the sample acoustic feature.

15. The method according to claim 14, wherein the performing the feature extraction on the sample reference speech comprises:
inputting the sample reference speech into an acoustic feature extraction network to obtain an initial sample acoustic feature; and
quantizing the initial sample acoustic feature to obtain the sample acoustic feature.

16. A speech synthesis apparatus, comprising:
processing circuitry configured to:
acquire a semantic feature of text information that corresponds to content of to-be-synthesized target audio;
acquire an acoustic feature of reference speech that corresponds to a target timbre of the to-be-synthesized target audio;
obtain an intermediate acoustic feature through a first-layer sub-model in a speech synthesis model, the first-layer sub-model being configured to output feature values of the intermediate acoustic feature based on the semantic feature and the acoustic feature;
obtain an audio synthesis feature through a second-layer sub-model in the speech synthesis model, the second-layer sub-model being configured to output feature values of the audio synthesis feature based on the intermediate acoustic feature; and
generate, based on the audio synthesis feature, target audio conforming to the target timbre of the reference speech.

17. The apparatus according to claim 16, wherein the processing circuitry is configured to:
obtain a one-dimensional acoustic feature based on the acoustic feature, each feature value of the one-dimensional acoustic feature being based on a summation of feature values in each column of the acoustic feature; and
concatenate the semantic feature and the one-dimensional acoustic feature to obtain a concatenated feature as input of the first-layer sub-model.

18. The apparatus according to claim 17, wherein the processing circuitry is configured to:
obtain a first intermediate acoustic feature value of the intermediate acoustic feature through inputting the concatenated feature to the first-layer sub-model; and
obtain an i-th intermediate acoustic feature value of the intermediate acoustic feature through inputting an (i−1)-th audio synthesis feature value of the audio synthesis feature and the concatenated feature to the first-layer sub-model, the (i−1)-th audio synthesis feature value being obtained through inputting the (i−1)-th intermediate acoustic feature value of the intermediate acoustic feature into the second-layer sub-model, wherein
the intermediate acoustic feature includes N intermediate acoustic feature values,
N is a positive integer greater than two, and
i is a positive integer ranging from 2 to N.

19. The apparatus according to claim 16, wherein the processing circuitry is configured to:
sequentially input intermediate acoustic feature values of the intermediate acoustic feature into the second-layer sub-model to obtain respective audio synthesis feature values of the audio synthesis feature.

20. The apparatus according to claim 19, wherein the processing circuitry is configured to:
provide a (j−1)-th audio synthesis feature value of the audio synthesis feature value to the first-layer sub-model that is configured to output a j-th intermediate acoustic feature value of the intermediate acoustic feature based on the semantic feature, the acoustic feature, and the (j−1)-th audio synthesis feature value, wherein
the intermediate acoustic feature includes N intermediate acoustic feature values,
N is a positive integer greater than two, and
j is a positive integer ranging from 2 to N.
